(19) United States
(12) Patent Application Publication
(10) Pub. No.: US 2026/0273948 A1
(43) Pub. Date: Sep. 17, 2026

(54) DIAPHRAGM PUMP, LIQUID EJECTION HEAD AND LIQUID EJECTION APPARATUS

(71) Applicant: CANON KABUSHIKI KAISHA, Tokyo (JP)

(72) Inventors: KATSUMI EDA, Tokyo (JP); HIROFUMI OTA, Kanagawa (JP); SATOSHI SHIMAZU, Kanagawa (JP); KAZUYUKI YOSHIDA, Kanagawa (JP)

(21) Appl. No.: 19/550,065

(22) Filed: Feb. 25, 2026

(30) Foreign Application Priority Data
Mar. 14, 2025 (JP) 2025-041178

(51) Int. Cl. B41J 2/175; B41J 2/14; F04B 43/04; F04B 53/10

(52) U.S. Cl. CPC B41J 2/17596; F04B 43/046; F04B 53/1037; B41J 2/14

(57) ABSTRACT

A diaphragm pump includes a diaphragm that is deformable, a supporting member that supports the diaphragm, an opening portion that is in communication with a space formed between the diaphragm and the supporting member, and a check valve having a plate shape that is provided between the opening portion and the space and is capable of opening and closing an opening that is in communication with the opening portion, the check valve has a flap piece portion that opens and closes the opening, an outer peripheral portion that surrounds the flap piece portion, and a flexible portion that connects the flap piece portion and the outer peripheral portion to each other, bending of the flexible portion allows the flap piece portion to open and close the opening, and the check valve includes a slit formed between the flap piece portion and the outer peripheral portion.

### BACKGROUND

### Field of the Technology

The present disclosure relates to a diaphragm pump, a liquid ejection head and a liquid ejection apparatus.

### Description of the Related Art

In the technical field of ink supply or the like of printing machines, a micropump that feeds a fixed amount of fluid under pressure with high precision is used. As is known, a diaphragm pump is used as a small micropump. A disadvantage of the size reduction of the pump is that each component of the pump is also reduced in size, so that high assembly precision is needed when assembling the components.

For example, Japanese Patent Laid-Open No. 2008-180161 discloses a diaphragm pump that is improved in pump performance.

### SUMMARY

Therefore, the present disclosure provides a technique that can reduce a decrease in pump performance.

To this end, a diaphragm pump according to the present disclosure is a diaphragm pump, comprising: a diaphragm that is deformable; a supporting member that supports the diaphragm; an opening portion that is in communication with a space formed between the diaphragm and the supporting member; and a check valve having a plate shape that is provided between the opening portion and the space and is configured to open and close an opening that is in communication with the opening portion, wherein the check valve has: a flap piece portion that opens and closes the opening; an outer peripheral portion that surrounds the flap piece portion and forms an outer shape of the check valve; and a flexible portion that connects the flap piece portion and the outer peripheral portion to each other, wherein the flexible portion bends to allow the flap piece portion to open and close the opening, and wherein the check valve includes a slit formed between the flap piece portion and the outer peripheral portion.

According to the present disclosure, a technique that can reduce a decrease in pump performance can be provided.

Features of the present disclosure will become apparent from the following description of embodiments with reference to the attached drawings. The following description of embodiments is described by way of example.

### BRIEF DESCRIPTION OF THE DRAWINGS

FIG. 1A is a schematic diagram showing a liquid ejection apparatus;

FIG. 1B is a block diagram showing a control system of the liquid ejection apparatus;

FIG. 2 is an exploded perspective view of a liquid ejection head;

FIG. 3A is a cross-sectional view taken along the line III-III in FIG. 2;

FIG. 3B is a cross-sectional view taken along the line III-III in FIG. 2;

FIG. 4 is a schematic perspective view of a circulation unit;

FIG. 5 is a vertical cross-sectional view schematically showing a circulation path;

FIG. 6 is a block diagram schematically showing the circulation path;

FIG. 7A is a cross-sectional view showing pressure adjusting means;

FIG. 7B is a cross-sectional view showing pressure adjusting means;

FIG. 7C is a cross-sectional view showing pressure adjusting means;

FIG. 8A is a diagram for illustrating a flow of ink in the liquid ejection head;

FIG. 8B is a diagram for illustrating a flow of ink in the liquid ejection head;

FIG. 8C is a diagram for illustrating a flow of ink in the liquid ejection head;

FIG. 8D is a diagram for illustrating a flow of ink in the liquid ejection head;

FIG. 8E is a diagram for illustrating a flow of ink in the liquid ejection head;

FIG. 9A is a schematic diagram showing a circulation path;

FIG. 9B is a schematic diagram showing the circulation path;

FIG. 10 is a diagram showing an opening plate;

FIG. 11 is a diagram showing an ejection element substrate;

FIG. 12A is a cross-sectional view showing an ink flow in a part of the ejection unit;

FIG. 12B is a cross-sectional view showing an ink flow in a different part of the ejection unit;

FIG. 12C is a cross-sectional view showing an ink flow in a different part of the ejection unit;

FIG. 13A is a cross-sectional view showing an ejection port and its periphery in an ejection module;

FIG. 13B is a cross-sectional view showing the ejection port and its periphery in the ejection module;

FIG. 14A is a cross-sectional view showing an ejection module according to a comparative example;

FIG. 14B is a cross-sectional view showing the ejection module according to the comparative example;

FIG. 15 is a diagram showing an ejection element substrate according to a comparative example;

FIG. 16A is a diagram showing a channel configuration of the liquid ejection head;

FIG. 16B is a diagram showing the channel configuration of the liquid ejection head;

FIG. 17A is an exterior view of a diaphragm pump;

FIG. 17B is an exterior view of the diaphragm pump;

FIG. 17C is an exterior view of the diaphragm pump;

FIG. 18 is a perspective view of the diaphragm pump without a cover;

FIG. 19 is a cross-sectional view taken along the line XIX-XIX in FIG. 18;

FIG. 20 is an exploded perspective view of the diaphragm pump without the cover;

FIG. 21A is a cross-sectional view of the diaphragm pump without the cover;

FIG. 21B is a cross-sectional view of the diaphragm pump without the cover;

FIG. 22A is a diagram showing a check valve;

FIG. 22B is a diagram showing the check valve;

FIG. 22C is a diagram showing the check valve;

FIG. 22D is a diagram showing the check valve;

FIG. 23A is a diagram showing a check valve according to a modification;

FIG. 23B is a diagram showing a check valve according to a modification;

FIG. 23C is a diagram showing a check valve according to a modification;

FIG. 23D is a diagram showing a check valve according to a modification;

FIG. 23E is a diagram showing a check valve according to a modification;

FIG. 24A is a diagram showing a check valve;

FIG. 24B is a diagram showing the check valve;

FIG. 24C is a diagram showing the check valve;

FIG. 25 is a diagram showing a check valve and a valve housing recess portion according to a modification;

FIG. 26 is an exploded perspective view of a diaphragm pump according to prior art;

FIG. 27A is a diagram showing a check valve set in a valve housing recess portion according to prior art;

FIG. 27B is a diagram showing the check valve set in the valve housing recess portion according to prior art; and

FIG. 27C is a diagram showing the check valve set in the valve housing recess portion according to prior art.

### DESCRIPTION OF THE EMBODIMENTS

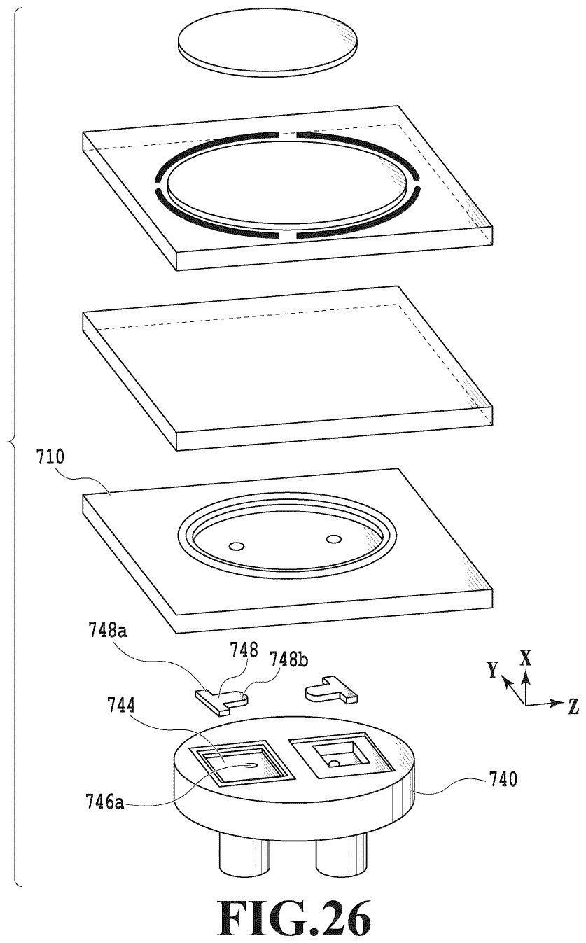

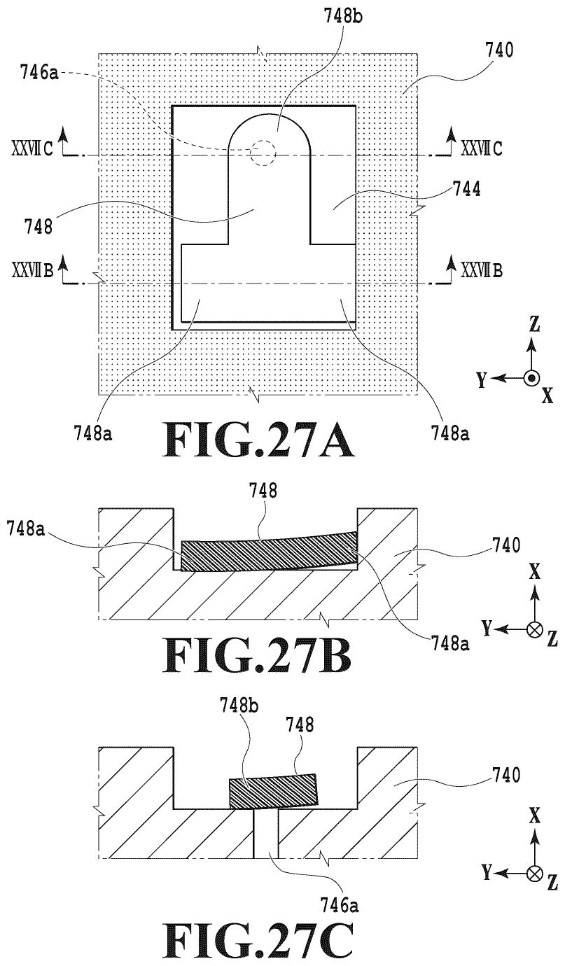

First, a prior art example shown in FIGS. 26, 27A, 27B and 27C will be described.

FIG. 26 is an exploded perspective view of a diaphragm pump according to Japanese Patent Laid-Open No. 2008-180161. In the diaphragm pump according to Japanese Patent Laid-Open No. 2008-180161, a check valve 748 that allows a flow in a +X direction in the drawing and blocks a flow in a −X direction is housed in a valve housing recess portion 744 formed in a flow path member 740. The check valve 748 has a base portion 748a having a rectangular shape and a flap piece 748b and is configured such that the flap piece 748b curls up with respect to the base portion 748a in the +X direction when allowing the flow in the +X direction of a liquid flowing in through an opening 746a. As such a diaphragm pump is reduced in size, and the distance (referred to as a clearance, hereinafter) between the base portion 748a having a rectangular shape and the wall of the valve housing recess portion 744 also decreases. In such a case, when housing the check valve 748 in the valve housing recess portion 744, the base portion 748a having a rectangular shape may get caught on the wall of the valve housing recess portion 744.

FIG. 27A is a top view of the check valve 748 set in the valve housing recess portion 744, FIG. 27B is a cross-sectional view taken along the line XXVIIb-XXVIIb in FIG. 27A, and FIG. 27C is a cross-sectional view taken along the line XXVIIc-XXVIIc in FIG. 27A. If the check valve 748 is set in the valve housing recess portion 744 in the state where the base portion 748a of the check valve 748 has gotten caught on the wall of the valve housing recess portion 744 as shown in FIG. 27B, the tip end of the flap piece 748b may be lifted as shown in FIG. 27C. If the diaphragm pump is assembled and used in this state, the opening 746a of the valve housing recess portion 744 may be unable to be properly sealed. In such a case, the performance of the pump may deteriorate. However, if the flap piece 748b is reduced in size or the valve housing recess portion 744 is increased in size in order to increase the clearance, the check valve 748 may be displaced in the valve housing recess portion 744 and the flap piece 748b may be misaligned with the opening 746a.

In the following, an embodiment of the present disclosure will be described with reference to the drawings.

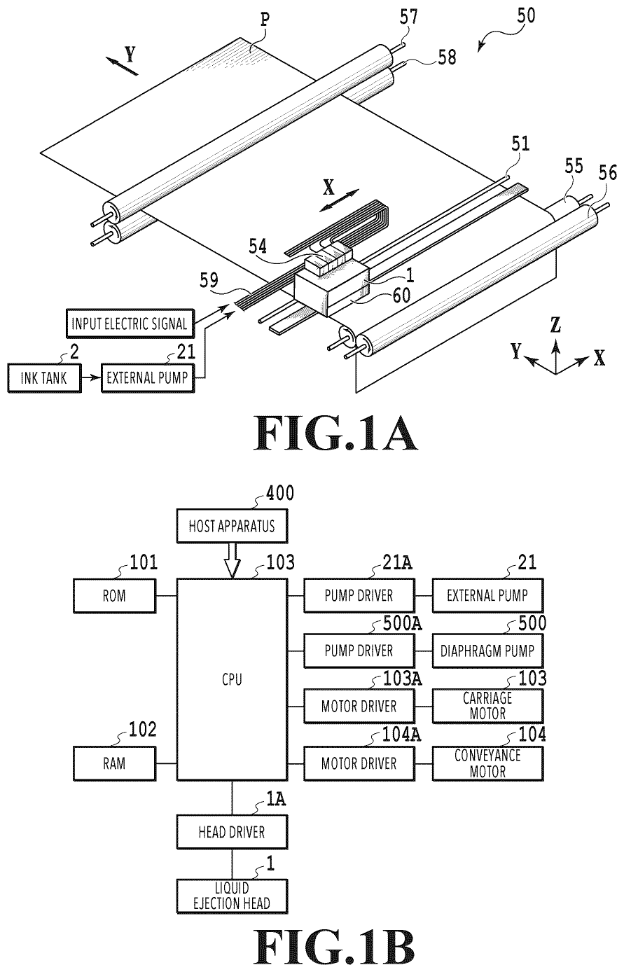

FIG. 1A is a schematic diagram showing a liquid ejection apparatus 50, and FIG. 1B is a block diagram showing a control system of the liquid ejection apparatus 50. The liquid ejection apparatus 50 is a serial-type inkjet printing apparatus that performs printing on a printing medium P by ejecting ink that is a liquid while moving a liquid ejection head 1 in the X direction. Alternatively, the liquid ejection apparatus 50 may be a so-called full-line type liquid ejection head that has an ejection port formed to cover the entire width of the printing medium P and can eject ink over the entire width of the printing medium P without moving in a main scanning direction.

The liquid ejection head 1 is mounted on a mount part (referred to also as a carriage, hereinafter) 60. The carriage 60 moves back and forth in the X direction, which is the main scanning direction, along a guide shaft 51. The printing medium P is conveyed in a Y direction, which is a sub-scanning direction that intersects (perpendicularly in this example) with the main scanning direction, by conveyance rollers 55, 56, 57 and 58. Note that in the drawings referred to in the following description, a Z direction is the vertical direction and intersects (perpendicularly in this example) with an X-Y plane defined by the X direction and the Y direction. The liquid ejection head 1 is configured such that the liquid ejection head 1 can be attached to and removed from the carriage 60 by a user.

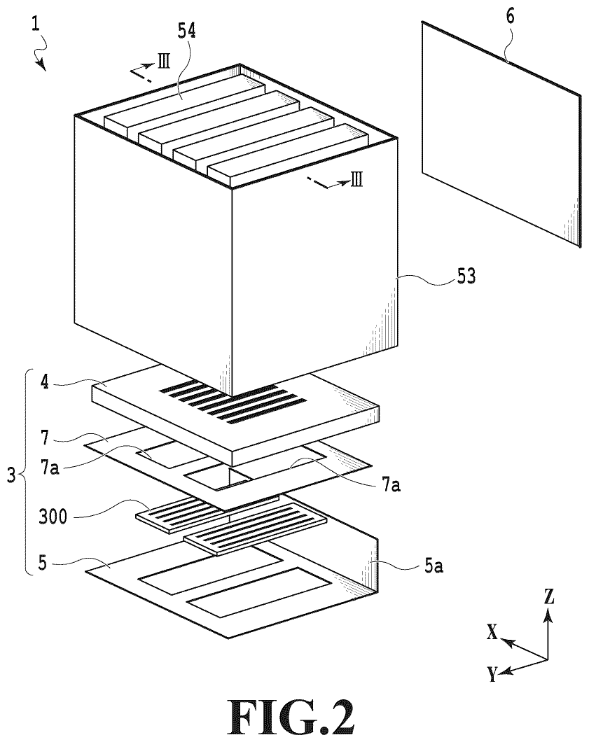

The liquid ejection head 1 is configured by including a circulation unit 54 and an ejection unit 3 (see FIG. 2) described later. The ejection unit 3 includes a plurality of ejection ports for ejecting a liquid and an ejection element that produces ejection energy for ejecting the liquid from each ejection port, although a specific configuration thereof will be described later.

The liquid ejection apparatus 50 includes an ink tank 2, which is a supply source of ink, and an external pump 21, and the ink stored in the ink tank 2 is supplied to the circulation unit 54 through an ink supply tube 59 by the driving force of the external pump 21.

The liquid ejection apparatus 50 forms a predetermined image on the printing medium P by repeating a printing scan in which the liquid ejection head 1 mounted on the carriage 60 performs printing by ejecting ink while moving in the main scanning direction and a conveyance operation in which the printing medium P is conveyed in the sub-scanning direction. Note that the liquid ejection head 1 according to this embodiment can eject four types of ink, specifically, black (K), cyan (C), magenta (M) and yellow (Y), and can print a full-color image with the ink. However, the ink that can be ejected by the liquid ejection head 1 is not limited to the four types of ink described above. The present disclosure can be applied to liquid ejection heads for ejecting other types of ink. That is, the types and the number of types of ink ejected by the liquid ejection head are not limited.

Furthermore, the liquid ejection apparatus 50 includes a cap member (not shown) at a position displaced from the conveyance path for the printing medium P in the X direction, and the cap member can cover an ejection port face of the liquid ejection head 1 in which the ejection port is formed. The cap member covers the ejection port face of the liquid ejection head 1 to prevent drying of the ejection port, protect the ejection port and absorb any ink from the ejection port, for example, when the liquid ejection head 1 is not in use for the printing operation.

Note that although the liquid ejection head 1 in the example shown in FIG. 1A includes four circulation units 54 corresponding to four types of ink, the liquid ejection head 1 can include any number of circulation units 54 depending on the types of liquids to be ejected. Furthermore, a plurality of circulation units 54 may be provided for the same type of liquid. All of the four types of ink do not have to be circulated, and only at least one type of ink may be circulated.

A CPU 103 serves as control means for controlling an operation of each part of the liquid ejection apparatus 50 according to a program, such as a processing procedure, stored in a ROM 101. A RAM 102 is used as a work area for the CPU 103 to perform processing, for example. The CPU 103 receives image data from a host apparatus 400 external to the liquid ejection apparatus 50 and controls a head driver 1A and driving of the ejection element provided in the ejection unit 3. The CPU 103 also controls drivers of various actuators provided in the liquid ejection apparatus. For example, the CPU 103 controls a motor driver 105A of a carriage motor 105 for moving the carriage 60 and a motor driver 104A of a conveyance motor 104 for conveying the printing medium P. The CPU 103 further controls a pump driver 500A that drives a diaphragm pump 500 described later and a pump driver 21A of the external pump 21, for example. Note that although FIG. 1B shows a configuration in which processing is performed by receiving image data from the host apparatus 400, the liquid ejection apparatus 50 may perform processing without data from the host apparatus 400.

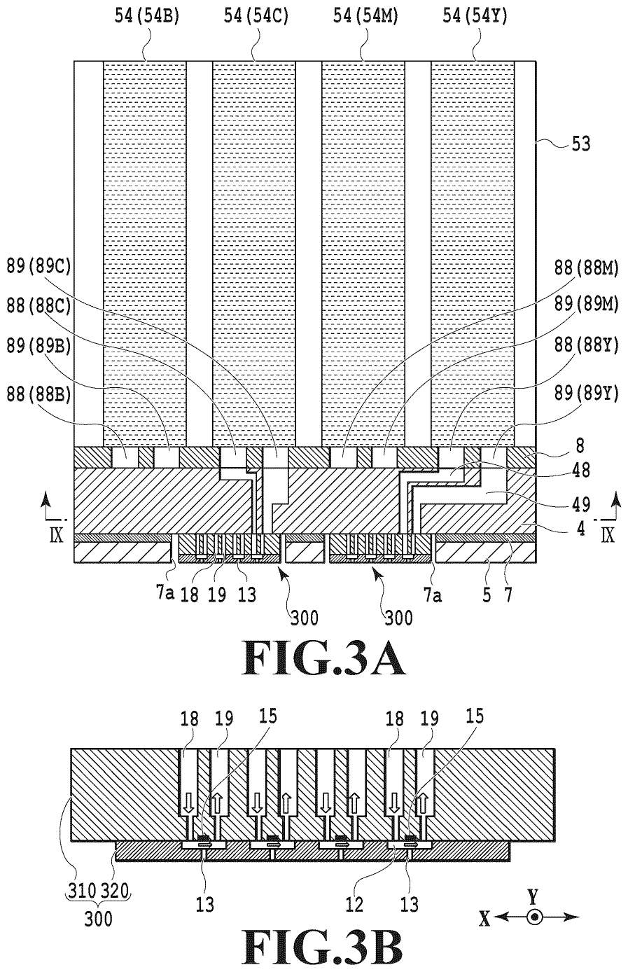

FIG. 2 is an exploded perspective view of the liquid ejection head 1 according to this embodiment. FIGS. 3A and 3B are cross-sectional views taken along the line III-III in FIG. 2, FIG. 3A is a vertical cross-sectional view of the whole liquid ejection head 1, and FIG. 3B is an enlarged view of an ejection module 300 in FIG. 3A.

As shown in FIG. 2, the liquid ejection head 1 is configured by including the circulation unit 54 and the ejection unit 3 for ejecting the ink supplied from the circulation unit 54 onto the printing medium P. The liquid ejection head 1 according to this embodiment is provided on the carriage 60 of the liquid ejection apparatus 50. The liquid ejection head 1 is fixed to and supported on the carriage 60 by positioning means (not shown) and an electrical contact. The liquid ejection head 1 performs printing on the printing medium P by ejecting ink while moving together with the carriage 60 in the main scanning direction (X direction) shown in FIG. 1A.

The external pump 21 connected to the ink tank 2 that is a supply source of the ink is provided with the ink supply tube 59 (see FIG. 1A). A liquid connector (not shown) is provided at a tip end of the ink supply tube 59. When the liquid ejection head 1 is mounted in the liquid ejection apparatus 50, the liquid connector provided at the tip end of the ink supply tube 59 is hermetically connected to a liquid connector insertion slot 53a provided in a head housing 53 of the liquid ejection head 1. In this way, an ink supply path from the ink tank 2 to the liquid ejection head 1 via the external pump 21 is formed. In this embodiment, since four types of ink are used, four sets of the ink tank 2, the external pump 21, the ink supply tube 59 and the circulation unit 54 corresponding to the respective types of ink are provided, and four ink supply paths corresponding to the four types of ink are independently formed.

As described above, the liquid ejection apparatus 50 according to this embodiment includes an ink supply system that supplies ink to the liquid ejection head 1 from the ink tank 2 that is external to the liquid ejection head 1. Note that the liquid ejection apparatus 50 according to this embodiment is not provided with an ink collection system that collects ink from the liquid ejection head 1 into the ink tank 2. Therefore, the liquid ejection head 1 is not provided with a connector insertion slot to which a tube for collecting ink from the liquid ejection head 1 into the ink tank 2 is connected, although the liquid ejection head 1 is provided with the liquid connector insertion slot 53a to which the ink supply tube 59 of the ink tank 2 is connected. Note that the liquid connector insertion slot 53a is provided for each ink.

In FIG. 3A, the circulation unit 54 includes a circulation unit 54B for black ink, a circulation unit 54C for cyan ink, a circulation unit 54M for magenta ink and an ink circulation unit 54Y for yellow ink. Each circulation unit has substantially the same configuration, and all the circulation units will be referred to as the circulation unit 54 in this embodiment unless the circulation units need to be distinguished from each other.

In FIGS. 2 and 3A, the ejection unit 3 includes two ejection modules 300, a first supporting member 4, a second supporting member 7, an electric wiring member (electric wiring tape) 5 and an electric contact substrate 6. As shown in FIG. 3B, the ejection module 300 includes a silicon substrate 310 having a thickness of 0.5 to 1 mm, a plurality of ejection elements 15 provided on one face of the silicon substrate 310, and an ejection port forming member 320. The ejection element 15 according to this embodiment is an electrothermal transducing element (heater) that produces thermal energy as ejection energy for ejecting a liquid, and electric power is supplied to each ejection element 15 through electric wiring formed on the silicon substrate 310 by a film deposition technique.

On a front face (lower face in FIG. 3B) of the silicon substrate 310, the ejection port forming member 320 is provided. In the ejection port forming member 320, a plurality of pressure chambers 12 corresponding to the plurality of ejection elements 15 and a plurality of ejection ports 13 for ejecting ink are formed by a photolithography technique. The pressure chamber 12 is a space to which the energy produced by the ejection element 15 is applied. Furthermore, in the silicon substrate 310, a common supply channel 18 and a common collecting channel 19 are formed. Furthermore, in the silicon substrate 310, a supply connection channel 323 that connects the common supply channel 18 and each pressure chamber 12 to each other and a collection connection channel 324 that connects the common collecting channel 19 and each pressure chamber 12 to each other are formed. In this embodiment, each ejection module 300 is configured to eject two types of ink.

Specifically, of the two ejection modules shown in FIG. 3A, the ejection module 300 located to the left in the drawing ejects black ink and cyan ink, and the ejection module 300 located to the right in the drawing ejects magenta ink and yellow ink. Note that this combination is just an example, and any combination of the ink is possible. One ejection module may be configured to eject one type of ink or may be configured to eject three or more types of ink. The two ejection modules 300 do not have to eject the same number of types of ink. Only one ejection module 300 may be provided, or three or more ejection modules 300 may be provided. Furthermore, in the example shown in FIG. 3A, two ejection port arrays extending in the Y direction are provided for one type of ink. The pressure chamber 12, the common supply channel 18 and the common collecting channel 19 are provided for each of the plurality of ejection ports 13 forming each ejection port array.

On the side of a back face (upper face in FIG. 3B) of the silicon substrate 310, an ink supply port and an ink collection port described later are formed. Ink is supplied from an ink supply channel 48 to the plurality of common supply channels 18 through the ink supply port, and is collected from the plurality of common collecting channels 19 into an ink collecting channel 49 through the ink collection port.

Note that the ink supply port and the ink collection port mentioned here mean openings through which ink is supplied and collected in ink circulation in a forward direction described later. That is, in the ink circulation in the forward direction, ink is supplied to each common supply channel 18 through the ink supply port and collected from each common collecting channel 19 through the ink collection port. However, in some cases, an ink circulation in which ink flows in the reverse direction occurs. In such a case, ink is supplied to the common collecting channels 19 through the ink collection port described above and collected from the common supply channels 18 through the ink supply port.

As shown in FIG. 3A, the ejection module 300 is bonded and fixed to one face (lower face in FIG. 3A) of the first supporting member 4 at the back face (upper face in FIG. 3A) thereof. In the first supporting member 4, an ink supply channel 48 and an ink collecting channel 49 are formed which penetrate the first supporting member 4 from one face to the other face. One opening of the ink supply channel 48 is in communication with the ink supply port described above in the silicon substrate 310, and one opening of the ink collecting channel 49 is in communication with the ink collection port described above in the silicon substrate 310. Note that the ink supply channel 48 and the ink collecting channel 49 are independently provided for each type of ink.

Furthermore, the second supporting member 7 having an opening 7a, through which the ejection module 300 is inserted, is bonded and fixed to the one face (lower face in FIG. 3A) of the first supporting member 4. The electric wiring member 5 electrically connected to the ejection module 300 is held on the second supporting member 7. The electric wiring member 5 is a member for applying an electric signal, for ejecting ink, to the ejection module 300. The electrical connection part between the ejection module 300 and the electric wiring member 5 is sealed by a sealing material (not shown) and protected from corrosion by ink or external impact.

As shown in FIG. 2, an electric contact substrate 6 is bonded by thermocompression bonding with an anisotropic conductive film (not shown) to an end portion 5a (see FIG. 2) of the electric wiring member 5, and the electric wiring member 5 and the electric contact substrate 6 are electrically connected to each other. The electric contact substrate 6 has an external signal input terminal (not shown) for receiving an electric signal from the liquid ejection apparatus 50.

Furthermore, a joint member 8 (FIG. 3A) is provided between the first supporting member 4 and the circulation unit 54. In the joint member 8, a supply port 88 and a collection port 89 are formed for each type of ink. The supply port 88 and the collection port 89 connect the ink supply channel 48 and the ink collecting channel 49 of the first supporting member 4 and channels formed in the circulation unit 54 to each other. Note that in FIG. 3A, a supply port 88B and a collection port 89B are ports for black ink, and a supply port 88C and a collection port 89C are ports for cyan ink. Similarly, a supply port 88M and a collection port 89M are ports for magenta ink, and a supply port 88Y and a collection port 89Y are ports for yellow ink.

Note that an opening at one end of each of the ink supply channel 48 and the ink collecting channel 49 in the first supporting member 4 has a small opening area matching the ink supply port and the ink collection port of the silicon substrate 310. On the other hand, an opening at the other end of each of the ink supply channel 48 and the ink collecting channel 49 in the first supporting member 4 has an enlarged opening area equal to the opening area of the larger opening in the joint member 8 that is shaped to match the channel in the circulation unit 54. With such a configuration, the increase of the channel resistance to the ink collected from each collecting channel is reduced. However, the shapes of the openings at one end and the other end of each of the ink supply channel 48 and the ink collecting channel 49 are not limited to the example described above.

In the liquid ejection head 1 having the configuration described above, the ink supplied to the circulation unit 54 flows through the supply port 88 of the joint member 8 and the ink supply channel 48 in the first supporting member 4 and then flows into the common supply channel 18 through the ink supply port of the ejection module 300. The ink then flows from the common supply channel 18 into the pressure chamber 12 through the supply connection channel 323, and part of the ink having flowed into the pressure chamber is ejected through the ejection port 13 by the action of the ejection element 15. The remaining ink that is not ejected flows from the pressure chamber 12 to the collection connection channel 324 and then to the common collecting channel 19 and then flows into the ink collecting channel 49 in the first supporting member 4 through the ink collection port. The ink having flowed into the ink collecting channel 49 then flows into and thus collected into the circulation unit 54 through the collection port 89 of the joint member 8.

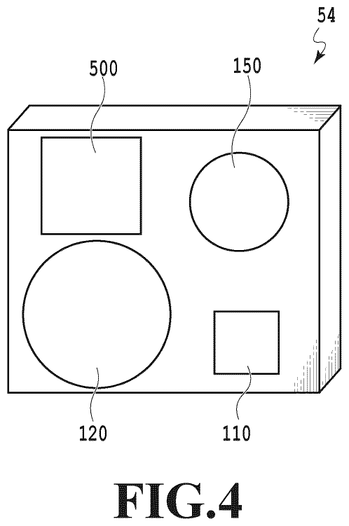

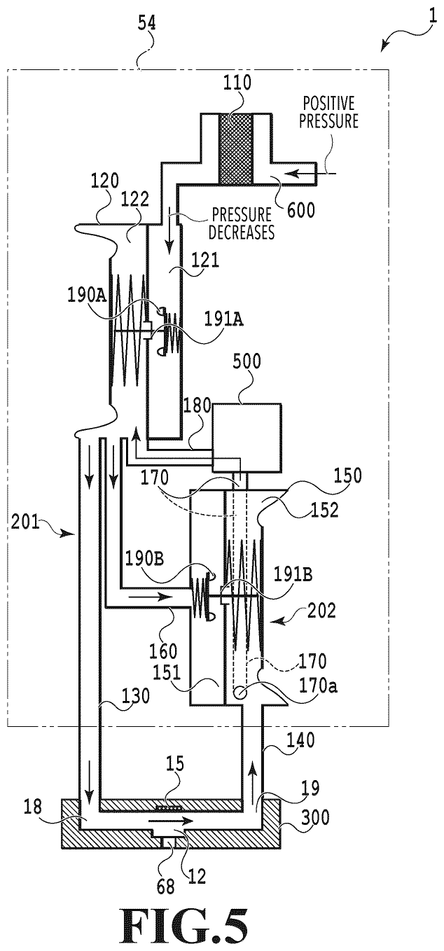

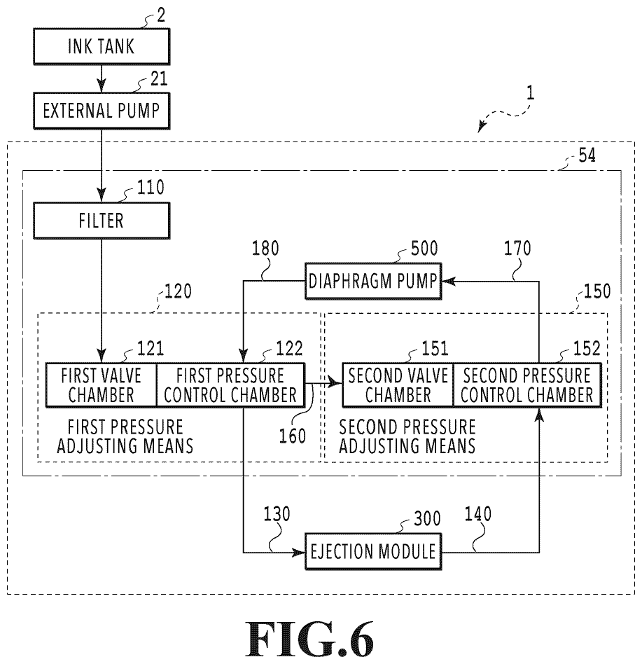

FIG. 4 is a schematic perspective view of one circulation unit 54 that corresponds to one type of ink used in the liquid ejection apparatus 50 according to this embodiment. The circulation unit 54 includes a filter 110, first pressure adjusting means 120, second pressure adjusting means 150 and a diaphragm pump 500. As shown in FIGS. 5 and 6 described later, these components are connected by channels to form a circulation path through which ink is supplied to and collected from the ejection module 300 in the liquid ejection head 1.

FIG. 5 is a vertical cross-sectional view schematically showing the circulation path for one type of ink (ink of one color) formed in the liquid ejection head 1. FIG. 6 is a block diagram schematically showing the circulation path shown in FIG. 5. As shown in FIGS. 5 and 6, the first pressure adjusting means 120 includes a first valve chamber 121 and a first pressure control chamber 122. The second pressure adjusting means 150 includes a second valve chamber 151 and a second pressure control chamber 152. The first pressure adjusting means 120 is configured to have a higher control pressure than the second pressure adjusting means 150. In this embodiment, by using the two pressure adjusting means 120 and 150, a circulation in a predetermined pressure range is achieved in the circulation path. Furthermore, the circulation path is configured such that ink flows through the pressure chamber 12 (ejection element 15) at a flowrate according to the difference in pressure between the first pressure adjusting means 120 and the second pressure adjusting means 150. In the following, with reference to FIGS. 5 and 6, the circulation path in the liquid ejection head 1 and a flow of ink in the circulation path will be described. Note that the arrows in the drawings indicate directions of the flow of ink.

First, the way in which the components in the liquid ejection head 1 are connected will be described. The external pump 21 for feeding ink contained in the ink tank 2 (see FIG. 1A) external to the liquid ejection head 1 to the liquid ejection head 1 is connected to the circulation unit 54 via the ink supply tube 59 (FIG. 6). An inlet channel 600 located in an upstream part of the circulation unit 54 is provided with the filter 110 and is in communication with the first valve chamber 121 of the first pressure adjusting means 120. That is, the inlet channel 600 is connected to a first channel 201. The first valve chamber 121 is in communication with the first pressure control chamber 122 via a communication port 191A that can be opened and closed by a valve 190A shown in FIG. 5.

The first pressure control chamber 122 is connected to a supply channel 130, a bypass channel 160 and a pump outlet channel 180 of the diaphragm pump 500. The supply channel 130 is connected to the common supply channel 18 via the ink supply port described above provided in the ejection module 300. The bypass channel 160 is connected to the second valve chamber 151 provided in the second pressure adjusting means 150. The second valve chamber 151 is in communication with the second pressure control chamber 152 via a communication port 191B that is opened and closed by a valve 190B shown in FIG. 5. Note that FIGS. 5 and 6 show an example in which one end of the bypass channel 160 is connected to the first pressure control chamber 122 of the first pressure adjusting means 120, and the other end of the bypass channel 160 is connected to the second valve chamber 151 of the second pressure adjusting means 150. However, one end of the bypass channel 160 may be connected to the supply channel 130, and the other end of the bypass channel may be connected to the second valve chamber 151.

The second pressure control chamber 152 is connected to a collecting channel 140. The collecting channel 140 is connected to the common collecting channel 19 via the ink collection port described above provided in the ejection module 300. Furthermore, the second pressure control chamber 152 is connected to the diaphragm pump 500 via a pump inlet channel 170. Note that in FIG. 5, an inlet port 170a is the inlet port of the pump inlet channel 170.

A flow of ink in the liquid ejection head 1 will be described. As shown in FIG. 6, ink contained in the ink tank 2 is pressurized by the external pump 21 provided in the liquid ejection apparatus 50, and the resulting positive-pressure ink flow is supplied to the circulation unit 54 in the liquid ejection head 1.

The ink supplied to the circulation unit 54 passes through the filter 110, which removes foreign substances such as dust and air bubbles from the ink, and then flows into the first valve chamber 121 provided in the first pressure adjusting means 120. Although the pressure of the ink decreases because of the pressure loss that occurs while the ink passes through the filter 110, the pressure of the ink at this point is positive. After that, the ink in the first valve chamber 121 flows into the first pressure control chamber 122 through the communication port 191 when the valve 190A is in an open state. Because of the pressure loss that occurs while the ink passes through the communication port 191, the pressure of the ink flowing into the first pressure control chamber 122 changes from positive to negative.

Next, a flow of ink in the circulation path will be described. The diaphragm pump 500 makes a diaphragm vibrate to cause a flow of a liquid in response to application of a voltage to a piezoelectric body. The diaphragm pump 500 operates by feeding ink sucked in from the pump inlet channel 170 on the upstream side to the pump outlet channel 180 on the downstream side. Therefore, when the pump is driven, the ink supplied to the first pressure control chamber 122 flows together with the ink fed from the pump outlet channel 180 into the supply channel 130 and the bypass channel 160. The diaphragm pump 500 will be described in detail later.

The ink having flowed into the supply channel 130 flows into the pressure chamber 12 through the ink supply port of the ejection module 300 and the common supply channel 18, and part of the ink is ejected through the ejection port 13 by the action (heat generation) of the ejection element 15. The remaining ink that is not used for ejection flows through the pressure chamber 12, passes through the common collecting channel 19 and then flows into the collecting channel 140 connected to the ejection module 300. The ink having flowed into the collecting channel 140 flows into the second pressure control chamber 152 of the second pressure adjusting means 150.

On the other hand, the ink having flowed into the bypass channel 160 from the first pressure control chamber 122 flows into the second valve chamber 151 and then flows into the second pressure control chamber 152 through the communication port 191B. The ink having flowed into the second pressure control chamber 152 through the bypass channel 160 and the ink collected from the collecting channel 140 are sucked into the diaphragm pump 500 through the pump inlet channel 170 by the action of the diaphragm pump 500. The ink sucked into the diaphragm pump 500 is then fed to the pump outlet channel 180 and flows into the first pressure control chamber 122 again. After that, the ink having flowed from the first pressure control chamber 122 into the second pressure control chamber 152 through the supply channel 130 and the ejection module 300 and the ink having flowed into the second pressure control chamber 152 through the bypass channel 160 flow into the diaphragm pump 500. The ink is then fed from the diaphragm pump 500 to the first pressure control chamber 122. In this way, the circulation of ink occurs in the circulation path.

Here, the channel connected to the pressure chamber 12 for supplying a liquid to the pressure chamber 12 is referred to as a first channel 201, and the other channel connected to the pressure chamber 12 is referred to as a second channel 202. Specifically, the pump outlet channel 180 and the supply channel 130 are collectively referred to as the first channel 201, and the collecting channel 140 and the pump inlet channel 170 are collectively referred to as the second channel 202. Furthermore, as shown in FIG. 5, the first channel 201 may include the first pressure adjusting means 120 that adjusts the pressure of the liquid in the first channel 201, and the pump outlet channel 180 and the supply channel 130 may be connected to each other via the first pressure adjusting means 120. Similarly, the second channel 202 may include the second pressure adjusting means 150 that adjusts the pressure of the liquid in the second channel 202, and the collecting channel 140 and the pump inlet channel 170 may be connected to each other via the second pressure adjusting means 150. That is, the diaphragm pump 500 has a suction hole 501 connected to the second channel 202 and a discharge hole 502 connected to the first channel 201 so that the liquid in the second channel 202 flows into the first channel 201.

As described above, in this embodiment, the diaphragm pump 500 enables the liquid to be circulated through the circulation path formed in the liquid ejection head 1. Therefore, the increase in viscosity of the ink and the deposition of precipitates of the ink as a coloring material in the ejection module 300 can be prevented, and the flowability of the ink and the ejection properties of the ink at the ejection port of the ejection module 300 can be kept excellent.

Furthermore, since the circulation path in this embodiment is completed in the liquid ejection head 1, the circulation path length can be substantially reduced compared with the case where the ink is circulated between the liquid ejection head 1 and the ink tank 2 external to the liquid ejection head 1. Therefore, the circulation of the ink can be achieved with a small diaphragm pump 500 that can be mounted in the liquid ejection head 1.

Furthermore, as the connection channel between the liquid ejection head 1 and the ink tank 2, only the channel for supplying ink is provided. That is, no channel is required for collecting ink from the liquid ejection head 1 into the ink tank 2. Therefore, only a tube for ink supply has to be provided in order to connect the ink tank 2 and the liquid ejection head 1 to each other, and no tube for ink collection has to be provided. Therefore, the number of tubes in the liquid ejection apparatus 50 can be reduced, and the overall size of the apparatus can be reduced.

Furthermore, since the number of tubes is reduced, the pressure variation of the ink due to swinging of tubes caused by main scanning of the liquid ejection head 1 can be reduced. Furthermore, the swinging of tubes during main scanning of the liquid ejection head 1 causes a driving load on the carriage motor that drives the carriage 60. Therefore, by reducing the number of tubes, the driving load on the carriage motor is reduced, and the main scanning mechanism including the carriage motor and the like can be simplified. Furthermore, ink does not need to be collected from the liquid ejection head into the ink tank, so that the external pump 21 can also be reduced in size. Thus, according to this embodiment, the liquid ejection apparatus 50 can be reduced in size and cost.

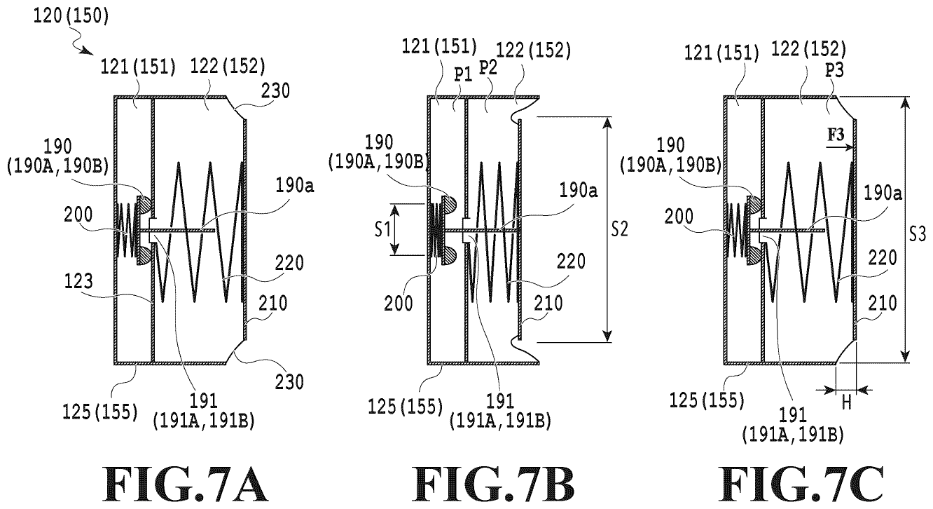

FIGS. 7A to 7C are cross-sectional views showing the pressure adjusting means 120 (150). With reference to FIGS. 7A to 7C, a configuration and an operation of the pressure adjusting means (first pressure adjusting means 120 and second pressure adjusting means 150) incorporated in the liquid ejection head 1 described above will be described. Note that the first pressure adjusting means 120 and the second pressure adjusting means 150 have substantially the same configuration. Therefore, the following description will be made by taking the first pressure adjusting means 120 as an example, and the reference numerals of the components of the second pressure adjusting means 150 corresponding to those of the first pressure adjusting means are shown in FIGS. 7A and 7C along with the reference numerals of the components of the first pressure adjusting means. As for the second pressure adjusting means 150, the first valve chamber 121 described below can be read as the second valve chamber 151, and the first pressure control chamber 122 can be read as the second pressure control chamber 152.

The first pressure adjusting means 120 has the first valve chamber 121 and the first pressure control chamber 122 formed in a cylindrical housing 125. The first valve chamber 121 and the first pressure control chamber 122 are divided by a partition 123 provided in the cylindrical housing 125. However, the first valve chamber 121 is in communication with the first pressure control chamber 122 via the communication port 191 formed in the partition 123. The first valve chamber 121 is provided with the valve 190, which switchably opens and closes the communication port 191 between the first valve chamber 121 and the first pressure control chamber 122. The valve 190 is held at a position opposed to the communication port 191 by a valve spring 200, and is configured to be able to come into intimate contact with the partition 123 under a biasing force of the valve spring 200. When the valve 190 comes into intimate contact with the partition 123, the flow of the ink through the communication port 191 is blocked. Note that in order to enhance the intimate contact with the partition 123, the part of the valve 190 that comes into contact with the partition 123 is preferably made of an elastic material. Furthermore, a valve shaft 190a that is to be inserted into the communication port 191 is provided at and protrudes from a central part of the valve 190. When the valve shaft 190a is pushed against the biasing force of the valve spring 200, the valve 190 separates from the partition 123 and allows the ink to flow through the communication port 191. In the following, the state where the flow of the ink through the communication port 191 is blocked by the valve 190 will be referred to as a “closed state”, and the state where the ink can flow through the communication port 191 will be referred to as an “open state”.

An opening of the cylindrical housing 125 is closed by a flexible member 230 and a pressing plate 210. The flexible member 230, the pressing plate 210, a peripheral wall of the housing 125 and the partition 123 form the first pressure control chamber 122. The pressing plate 210 is configured to be able to be displaced as the flexible member 230 is displaced. Although the materials of the pressing plate 210 and the flexible member 230 are not particularly limited, the pressing plate 210 may be formed by a resin molded component, and the flexible member 230 may be formed by a resin film, for example. In that case, the pressing plate 210 can be fixed to the flexible member 230 by thermal welding.

A pressure adjusting spring 220 (biasing member) is provided between the pressing plate 210 and the partition 123. By the biasing force of the pressure adjusting spring 220, the pressing plate 210 and the flexible member 230 are biased in such a direction that the internal volume of the first pressure control chamber 122 increases as shown in FIG. 7A. If the pressure in the first pressure control chamber 122 decreases, the pressing plate 210 and the flexible member 230 are displaced against the pressure of the pressure adjusting spring 220 in such a direction that the internal volume of the first pressure control chamber 122 decreases. When the internal volume of the first pressure control chamber 122 decreases to a predetermined volume, the pressing plate 210 abuts on the valve shaft 190a of the valve 190. After that, as the internal volume of the first pressure control chamber 122 further decreases, the valve 190 moves with the valve shaft 190a against the biasing force of the valve spring 200 and separates from the partition 123. In this way, the communication port 191 enters the open state (the state shown in FIG. 7B).

In this embodiment, the connections in the circulation path are set such that the pressure in the first valve chamber 121 is higher than the pressure in the first pressure control chamber 122 when the communication port 191 enters the open state. Therefore, when the communication port 191 enters the open state, the ink flows from the first valve chamber 121 into the first pressure control chamber 122. This flow of ink causes the flexible member 230 and the pressing plate 210 to be displaced in such a direction that the internal volume of the first pressure control chamber 122 increases. As a result, the pressing plate 210 separates from the valve shaft 190a of the valve 190, the valve 190 comes into intimate contact with the partition 123 under the biasing force of the valve spring 200, and the communication port 191 enters the closed state (the state shown in FIG. 7C).

As described above, in the first pressure adjusting means 120 in this embodiment, when the pressure in the first pressure control chamber 122 decreases to a predetermined pressure or lower (when the negative pressure becomes stronger, for example), ink flows from the first valve chamber 121 into the first pressure control chamber 122 through the communication port 191. As a result, the pressure in the first pressure control chamber 122 does not further decrease. Thus, the first pressure control chamber 122 is controlled to be kept in a predetermined pressure range.

Next, the pressure in the first pressure control chamber 122 will be described in more detail.

Consider the state (the state shown in FIG. 7B) where the flexible member 230 and the pressing plate 210 are displaced according to the pressure in the first pressure control chamber 122, the pressing plate 210 abuts on the valve shaft 190a, and the communication port 191 enters the open state as described above. In this state, a relation between forces acting on the pressing plate 210 is expressed by the following formula 1.

P2×S2+F2+(P1−P2)×S1+F1=0 Formula 1

The formula 1 can be rearranged in terms of P2 as follows.

P2=−(F1+F2+P1×S1)/(S2−S1) Formula 2
P1: the pressure in the first valve chamber 121 (gauge pressure)
P2: the pressure in the first pressure control chamber 122 (gauge pressure)
F1: the spring force of the valve spring 200
F2: the spring force of the pressure adjusting spring 220
S1: the pressure receiving area of the valve 190
S2: the pressure receiving area of the pressing plate 210

Here, as for the spring force F1 of the valve spring 200 and the spring force F2 of the pressure adjusting spring 220, the direction in which the springs press the valve 190 and the pressing plate 210 is the positive direction (the left direction in FIGS. 7A to 7C). As for the pressure P1 in the first valve chamber 121 and the pressure P2 in the first pressure control chamber 122, P1 is set to satisfy the relation P1≥P2.

The pressure P2 in the first pressure control chamber 122 at the time when the communication port 191 is in the open state is determined according to the formula 2, and when the communication port 191 enters the open state, the ink flows from the first valve chamber 121 into the first pressure control chamber 122, since there is the relation P1>P2. As a result, the pressure P2 in the first pressure control chamber 122 does not further decrease and is kept in a predetermined pressure range.

On the other hand, when the pressing plate 210 does not abut on the valve shaft 190a and the communication port 191 is in the closed state as shown in FIG. 7C, the relation between the forces acting on the pressing plate 210 is expressed by the formula 3.

P3×S3+F3=0 Formula 3

The formula 3 can be rearranged in terms of P3 as follows.

P3=−F3/S3 Formula 4
F3: the spring force of the pressure adjusting spring 220 at the time when the pressing plate 210 and the valve shaft 190a do not abut on each other
P3: the pressure (gauge pressure) in the first pressure control chamber 122 at the time when the pressing plate 210 and the valve shaft 190a do not abut on each other
S3: the pressure receiving area of the pressing plate 210 at the time when the pressing plate 210 and the valve shaft 190a do not abut on each other

Here, FIG. 7C shows a state where the pressing plate 210 and the flexible member 230 are displaced to the limit of displacement in the right direction in the drawing. The pressure P3 in the first pressure control chamber 122, the spring force F3 of the pressure adjusting spring 220 and the pressure receiving area S3 of the pressing plate 210 vary with the amount of displacement during displacement of the pressing plate 210 and the flexible member 230 until the state in FIG. 7C is reached. Specifically, when the pressing plate 210 and the flexible member 230 are located more leftward than those in the state shown in FIG. 7C, the pressure receiving area S3 of the pressing plate 210 is smaller, and the spring force F3 of the pressure adjusting spring 220 is greater. Therefore, according to the relation of the formula 4, the pressure P3 in the first pressure control chamber 122 is smaller. Therefore, according to the formulas 2 and 4, the pressure in the first pressure control chamber 122 gradually increases (that is, the negative pressure decreases to a value closer to the positive pressure side) when the pressure adjusting means transitions from the state in FIG. 7B to the state in FIG. 7C. That is, the pressure in the first pressure control chamber gradually increases while the pressing plate 210 and the flexible member 230 are gradually displaced in the left direction from the state where the communication port 191 is in the open state until the internal volume of the first pressure control chamber 122 eventually reaches the limit of change. That is, the negative pressure decreases.

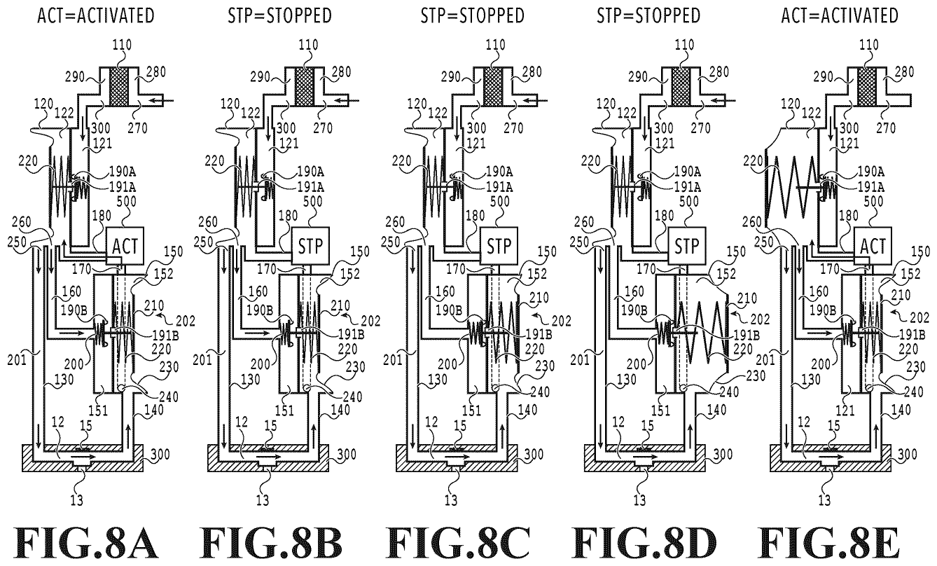

FIGS. 8A to 8E are diagrams for illustrating a flow of ink in the liquid ejection head 1. With reference to FIGS. 8A to 8E, a circulation of ink in the liquid ejection head 1 will be described. FIG. 8A is a diagram schematically showing a flow of ink in a printing operation in which printing is performed by ejecting ink from the ejection port 13. Note that the arrows in the drawing indicate flows of ink. In this embodiment, when the printing operation is performed, both the external pump 21 and the diaphragm pump 500 are activated. Note that the external pump 21 and the diaphragm pump 500 may be activated in other operations than the printing operation. The external pump 21 and the diaphragm pump 500 do not have to be activated in association and may be independently activated.

In the printing operation, the diaphragm pump 500 is in an On state (activated state), and the ink having flowed out of the first pressure control chamber 122 flows into the supply channel 130 and the bypass channel 160. The ink having flowed into the supply channel 130 passes through the ejection module 300, then flows into the collecting channel 140 and is then supplied to the second pressure control chamber 152.

On the other hand, the ink having flowed from the first pressure control chamber 122 into the bypass channel 160 flows into the second pressure control chamber 152 through the second valve chamber 151. The ink having flowed into the second pressure control chamber 152 passes through the pump inlet channel 170, the diaphragm pump 500 and the pump outlet channel 180 and then flows into the first pressure control chamber 122 again. At this point, the control pressure of the first valve chamber 121 is set to be higher than the control pressure of the first pressure control chamber 122 based on the relation of the formula 2 described above. Therefore, the ink in the first pressure control chamber 122 does not flow to the first valve chamber 121 but is supplied to the ejection module 300 through the supply channel 130 again. The ink having flowed into the ejection module 300 flows into the first pressure control chamber 122 again through the collecting channel 140, the second pressure control chamber 152, the pump inlet channel 170, the diaphragm pump 500 and the pump outlet channel 180. In this way, an ink circulation completed in the liquid ejection head 1 occurs.

In the ink circulation described above, the circulation amount (flowrate) of the ink in the ejection module 300 is determined by the pressure difference between the control pressures of the first pressure control chamber 122 and the second pressure control chamber 152. The pressure difference is set to achieve such a circulation amount that the increase in viscosity of the ink in the vicinity of the ejection port in the ejection module 300 can be reduced. After the ink is consumed for printing, the first pressure control chamber 122 is replenished with ink from the ink tank 2 through the filter 110 and the first valve chamber 121. A mechanism for replenishing the consumed ink will be briefly described. When the ink is consumed for printing and the amount of ink in the circulation path accordingly decreases, the pressure in the first pressure control chamber decreases, and as a result, the amount of ink in the first pressure control chamber 122 also decreases. As the amount of ink in the first pressure control chamber 122 decreases, the internal volume of the first pressure control chamber 122 decreases. As a result of the decrease in internal volume of the first pressure control chamber 122, the communication port 191A enters the open state, and ink is supplied from the first valve chamber 121 to the first pressure control chamber 122. The supplied ink experiences a pressure loss when the ink passes through the communication port 191A from the first valve chamber 121, and when the ink flows into the first pressure control chamber 122, the pressure of the ink changes from positive to negative. As the ink flows from the first valve chamber 121 into the first pressure control chamber 122, the pressure in the first pressure control chamber increases, the internal volume of the first pressure control chamber thus increases, and the communication port 191A enters the closed state. In this way, as the ink is consumed, the communication port 191A repeatedly switches between the open state and the closed state. When the ink is not consumed, the communication port 191A is maintained in the closed state.

FIG. 8B is a diagram schematically showing a flow of ink immediately after the printing operation ends and the diaphragm pump 500 enters an OFF state (stopped state). At the time when the printing operation ends and the diaphragm pump 500 is turned off, the pressure in the first pressure control chamber 122 and the pressure in the second pressure control chamber 152 are both at the respective control pressures in the printing operation. Therefore, ink moves as shown in FIG. 8B according to the pressure difference between the pressure in the first pressure control chamber 122 and the pressure in the second pressure control chamber 152. Specifically, ink is supplied from the first pressure control chamber 122 to the ejection module 300 through the supply channel 130, and then a flow of ink from the ejection module 300 to the second pressure control chamber 152 through the collecting channel 140 continues occurring. In addition, a flow of ink from the first pressure control chamber 122 to the second pressure control chamber 152 through the bypass channel 160 and the second valve chamber 151 also continues occurring.

An amount of ink equal to the amount of ink having moved from the first pressure control chamber 122 to the second pressure control chamber 152 in these flows of ink is supplied from the ink tank 2 to the first pressure control chamber 122 through the filter 110 and the first valve chamber 121. Therefore, the internal volume of the first pressure control chamber 122 is kept constant. According to the relation of the formula 2 described above, when the internal volume of the first pressure control chamber 122 is constant, the spring force F1 of the valve spring 200, the spring force F2 of the pressure adjusting spring 220, the pressure receiving area S1 of the valve 190 and the pressure receiving area S2 of the pressing plate 210 are kept constant. Therefore, the pressure in the first pressure control chamber 122 depends on the change in pressure P1 (gauge pressure) in the first valve chamber 121. Therefore, when there is no change in pressure P1 in the first valve chamber 121, the pressure P2 in the first pressure control chamber 122 is kept at the control pressure in the printing operation.

On the other hand, the pressure in the second pressure control chamber 152 temporally changes as the internal volume changes as the ink flows from the first pressure control chamber 122 into the second pressure control chamber 152. Specifically, starting from the state in FIG. 8B, the pressure in the second pressure control chamber 152 changes according to the formula 2 until the communication port 191 enters the closed state and the second valve chamber 151 and the second pressure control chamber 152 are disconnected from each other as shown in FIG. 8C. After that, the pressing plate 210 and the valve shaft 190a separate from each other, and the communication port 191 enters the closed state. Then, as shown in FIG. 8D, ink flows into the second pressure control chamber 152 through the collecting channel 140. This flow of ink causes displacement of the pressing plate 210 and the flexible member 230, and the pressure in the second pressure control chamber 152 changes according to the formula 4 until the internal volume of the second pressure control chamber 152 reaches a maximum volume. That is, the pressure in the second pressure control chamber 152 increases.

Note that in the state shown in FIG. 8C, no flow of ink from the first pressure control chamber 122 to the second pressure control chamber 152 through the bypass channel 160 and the second valve chamber 151 occurs. Therefore, only the flow of the ink that is supplied from the first pressure control chamber 122 to the ejection module 300 through the supply channel 130 and then reaches the second pressure control chamber 152 through the collecting channel 140 occurs. As described above, the movement of ink from the first pressure control chamber 122 to the second pressure control chamber 152 occurs according to the pressure difference between the pressure in the first pressure control chamber 122 and the pressure in the second pressure control chamber 152. Therefore, the movement of the ink stops when the pressure in the second pressure control chamber 152 becomes equal to the pressure in the first pressure control chamber 122.

Furthermore, in the state where the pressure in the second pressure control chamber 152 is equal to the pressure in the first pressure control chamber 122, the second pressure control chamber 152 is expanded to the state shown in FIG. 8D. When the second pressure control chamber 152 is expanded as shown in FIG. 8D, a reservoir portion capable of storing ink is formed in the second pressure control chamber 152. Note that the transition to the state shown in FIG. 8D after the diaphragm pump 500 is stopped approximately takes one to two minutes, although the time depends on the shape and size of the channels and the properties of the ink. When the diaphragm pump 500 is activated in the state shown in FIG. 8D in which the ink is stored in the reservoir portion, the ink in the reservoir portion is supplied to the first pressure control chamber 122 by the action of the diaphragm pump 500. As a result, as shown in FIG. 8E, the amount of ink in the first pressure control chamber 122 increases, and the flexible member 230 and the pressing plate 210 are displaced in an expansion direction. Then, as the diaphragm pump 500 continues operating, the state in the circulation path changes as shown in FIG. 8A.

Note that although FIG. 8A illustrates an example of the printing operation in the above description, the ink circulation may occur without the printing operation. In such a case, the flows of ink shown in FIGS. 8A to 8E also occur in response to activation and stopping of the diaphragm pump 500.

Furthermore, although this embodiment has been described with reference to an example in which the communication port 191B of the second pressure adjusting means 150 enters the open state when the diaphragm pump 500 is activated and an ink circulation occurs and enters the closed state when the ink circulation stops, this is not intended to be limiting. The control pressures may be set such that the communication port 191B of the second pressure adjusting means 150 is in the closed state even when the diaphragm pump 500 is activated and an ink circulation occurs. In the following, this example as well as the role of the bypass channel 160 will be specifically described.

The bypass channel 160 that connects the first pressure adjusting means 120 and the second pressure adjusting means 150 to each other is provided in order to prevent any negative pressure in the circulation path higher than a predetermined value from exerting an influence on the ejection module 300. Furthermore, the bypass channel 160 is provided in order to supply ink to the pressure chamber 12 from both the supply channel 130 and the collecting channel 140. That is, the bypass channel 160 connects the first channel 201 and the second channel 202 without the intervention of the pressure chamber 12.

First, an example will be described in which when the negative pressure is stronger than a predetermined value, the bypass channel 160 prevents the influence of the negative pressure from being exerted on the ejection module 300. For example, the properties (such as viscosity) of the ink may change as the environmental temperature changes. If the viscosity of the ink changes, the pressure loss in the circulation path also changes. For example, if the viscosity of the ink decreases, the pressure loss in the circulation path decreases. As a result, the flowrate of the diaphragm pump 500, which is operating with a fixed operation amount, increases, and the flowrate in the ejection module 300 increases. On the other hand, the viscosity of the ink in the ejection module 300 is kept constant even if the environmental temperature changes. Since the flowrate of the ink flowing in the ejection module 300 increases while the viscosity of the ink in the ejection module 300 remains unchanged, the negative pressure in the ejection module 300 increases because of the flow resistance. If the negative pressure in the ejection module 300 becomes stronger than the predetermined value in this way, the meniscus at the ejection port 13 may be broken, outside air may be sucked into the circulation path, and the normal ejection may be unable to be achieved. Even if the meniscus is not broken, the negative pressure in the pressure chamber 12 may become stronger than a predetermined value and exert an influence on the ejection.

In view of this, in this embodiment, the bypass channel 160 is provided in the circulation path. Since the bypass channel 160 is provided, when the negative pressure becomes stronger than a predetermined value, the ink also flows to the bypass channel 160 so that the pressure in the ejection module 300 can be kept constant. Therefore, for example, the control pressure of the second pressure adjusting means 150 may be set such that the communication port 191B is maintained in the closed state even when the diaphragm pump 500 is operating. And the control pressure of the second pressure adjusting means may be set such that the communication port 191 of the second pressure adjusting means 150 enters the open state when the negative pressure becomes stronger than a predetermined value. That is, the communication port 191B can be in the closed state when the diaphragm pump 500 is operating, as long as the meniscus is not broken due to a change in flowrate of the pump due to a change in viscosity of the ink due to an environmental change or the like or a predetermined negative pressure is maintained.

Next, an example will be described in which the bypass channel 160 is provided in order to supply ink to the pressure chamber 12 from both the supply channel 130 and the collecting channel 140. A pressure change in the circulation path may occur because of the ejection operation of the ejection element 15. This is because a force of sucking ink into the pressure chamber occurs in the ejection operation. Note that although the definition of duty is variable depending on various conditions, the definition of the term here is as follows: a duty of 100% means a state where a 1200-dpi grid is printed with one drop of ink having a volume of 4 μl. Printing with high duty means printing with a duty of 100%, for example.

In the following, a case will be described in which when printing with high duty continues, the ink supplied to the pressure chamber 12 is supplied from both the side of the supply channel 130 and the side of the collecting channel 140. If printing with high duty continues, the amount of ink flowing from the pressure chamber 12 into the second pressure control chamber 152 through the collecting channel 140 decreases. On the other hand, since the diaphragm pump 500 feeds a fixed amount of ink, the inflow of ink and the outflow of ink of the second pressure control chamber 152 go out of balance, the amount of ink in the second pressure control chamber 152 decreases, the negative pressure in the second pressure control chamber 152 becomes stronger, and the second pressure control chamber 152 is reduced in size. As a result of the negative pressure in the second pressure control chamber 152 becoming stronger, the amount of ink flowing into the second pressure control chamber 152 through the bypass channel 160 increases, and the second pressure control chamber 152 becomes stable in the state where the inflow of ink and the outflow of ink are balanced. In this way, as a result, the negative pressure in the second pressure control chamber 152 becomes stronger according to the duty. Furthermore, in the configuration in which the communication port 191B is in the closed state when the diaphragm pump 500 is operating as described above, the communication port 191B enters the open state according to the duty, and the ink flows from the bypass channel 160 into the second pressure control chamber 152.

If printing with high duty further continues, the amount of ink flowing from the pressure chamber 12 to the second pressure control chamber 152 through the collecting channel 140 decreases, and the amount of ink flowing from the bypass channel 160 into the second pressure control chamber 152 through the communication port 191B increases instead. If this state further continues, the amount of ink flowing from the pressure chamber 12 into the second pressure control chamber 152 through the collecting channel 140 becomes zero, and all the ink flowing out to the diaphragm pump 500 is the ink flowing into the second pressure control chamber 152 through the communication port 191B. If this state further continues, the ink in the second pressure control chamber 152 flows back to the pressure chamber 12 through the collecting channel 140. In this state, the ink flowing out of the second pressure control chamber 152 to the diaphragm pump 500 and to the pressure chamber 12 is the ink flowing into the second pressure control chamber 152 from the bypass channel 160 through the communication port 191B. In this case, the pressure chamber 12 is charged with the ink from the supply channel 130 and the ink from the collecting channel 140 for ejection.

The backflow of the ink that occurs when the duty is high is a phenomenon that occurs due to the presence of the bypass channel 160. Furthermore, although an example has been described above in which the communication port 191B of the second pressure adjusting means enters the open state in response to the back flow of ink, the backflow of ink may occur when the communication port 191B of the second pressure adjusting means is in the open state. Furthermore, even in an arrangement that does not include the second pressure adjusting means, the backflow of ink described above can occur due to the presence of the bypass channel 160.

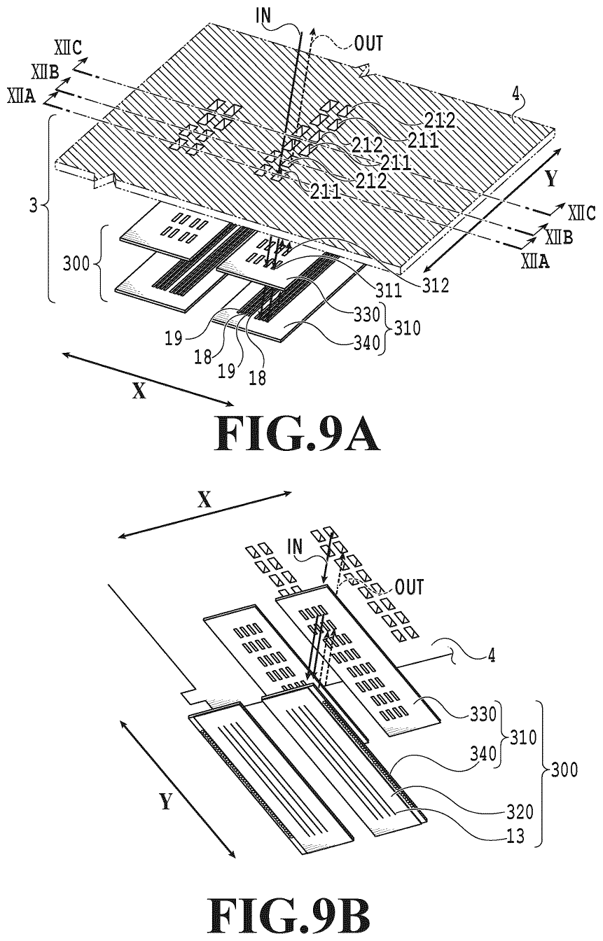

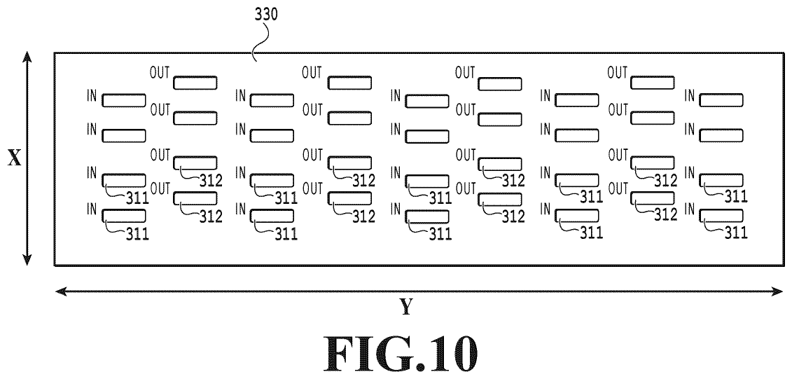

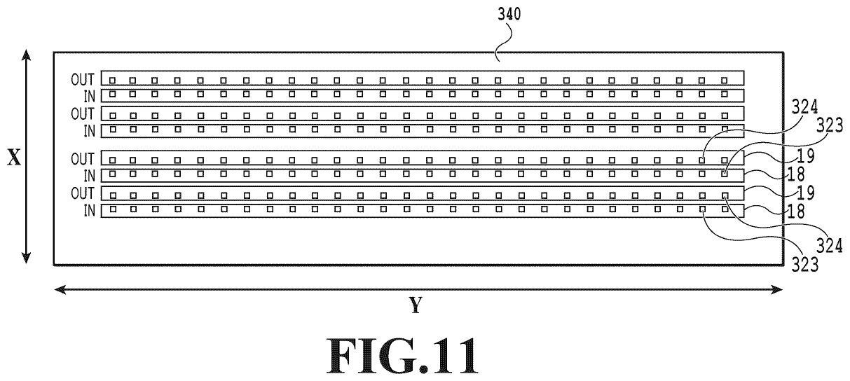

FIGS. 9A and 9B are schematic diagrams showing a circulation path for ink of one color in the ejection unit 3 according to this embodiment. FIG. 9A is an exploded perspective view of the ejection unit 3 viewed from the side of the first supporting member 4, and FIG. 9B is an exploded perspective view of the ejection unit 3 viewed from the side of the ejection module 300. Note that the arrows indicated by IN and OUT in the drawings indicate flows of ink, and although a flow of ink of one color will be described, other types of ink flow in the same manner. In addition, the second supporting member 7 and the electric wiring member 5 are not shown in FIGS. 9A and 9B and will not be mentioned in the description of the configuration of the ejection unit. In addition, FIG. 9A shows a cross section of the first supporting member 4 taken along the line IX-IX in FIG. 3A. The ejection module 300 includes an ejection element substrate 340 and an opening plate 330. FIG. 10 is a diagram showing the opening plate 330, and FIG. 11 is a diagram showing the ejection element substrate 340.

The ejection unit 3 is supplied with ink from the circulation unit 54 via the joint member 8 (see FIG. 3A). A path of ink after the ink passes through the joint member 8 until the ink returns to the joint member 8 will be described. Note that in the drawings described below, the joint member 8 is not shown.

The ejection module 300 includes the ejection element substrate 340, which is the silicon substrate 310, and the opening plate 330 and further includes the ejection port forming member 320. The ejection element substrate 340, the opening plate 330 and the ejection port forming member 320 are overlaid and bonded to each other such that the ink channels are in communication with each other to form the ejection module 300, and supported on the first supporting member 4. The first supporting member 4 and the ejection module 300 supported thereon form the ejection unit 3. The ejection element substrate 340 includes the ejection port forming member 320, the ejection port forming member 320 includes a plurality of ejection port arrays having a plurality of ejection ports 13 arranged in arrays, and part of the ink supplied through the ink channels in the ejection module 300 is ejected from the ejection ports 13. The ink that has not been ejected is collected through the ink channels in the ejection module 300.

As shown in FIGS. 9A, 9B and 10, the opening plate 330 includes a plurality of arrays of ink supply ports 311 and a plurality of arrays of ink collection ports 312. As shown in FIG. 11, the ejection element substrate 340 includes a plurality of arrays of supply connection channels 323 and a plurality of arrays of collection connection channels 324. The ejection element substrate 340 further includes a common supply channel 18 that is in communication with the plurality of supply connection channels 323 and a common collecting channel 19 that is in communication with the plurality of collection connection channels 324. The ink channels in the ejection unit 3 are formed by connecting the ink supply channels 48 and the ink collecting channels 49 provided in the first supporting member 4 (see FIG. 3A) and the channels provided in the ejection module 300. A supporting member supply port 211 is a cross-sectional opening forming the ink supply channel 48, and a supporting member collection port 212 is a cross-sectional opening forming the ink collecting channel 49.

The ink supplied to the ejection unit 3 is supplied from the side of the circulation unit 54 (see FIG. 3A) to the ink supply channel 48 (see FIG. 3A) of the first supporting member 4. The ink having flowed through the supporting member supply port 211 in the ink supply channel 48 is supplied to the common supply channel 18 of the ejection element substrate 340 through the ink supply port 311 of the opening plate 330 and enters the supply connection channel 323. This is the end of a supply-side channel. After that, the ink flows to the collection connection channel 324 in a collection-side channel through the pressure chamber 12 (see FIG. 3B) of the ejection port forming member 320. The flow of the ink in the pressure chamber 12 will be described in detail later.

In the collection-side channel, the ink having entered the collection connection channel 324 flows to the common collecting channel 19. After that, the ink flows from the common collecting channel 19 to the ink collecting channel 49 of the first supporting member 4 through the ink collection port 312 of the opening plate 330, passes through the supporting member collection port 212 and is collected in the circulation unit 54.

A region of the opening plate 330 in which the ink supply ports 311 and the ink collection ports 312 are not formed corresponds to a region of the first supporting member 4 that separates the supporting member supply ports 211 and the supporting member collection ports 212 from each other. In this region, the first supporting member 4 also has no opening. Such a region is used as a bonding region in a case where the ejection module 300 and the first supporting member 4 are bonded to each other.

Referring to FIG. 10, in the opening plate 330, a plurality of openings arranged in the X direction are arranged in a plurality of rows in the Y direction, and the openings for supply (IN) and the openings for collection (OUT) are alternately arranged in the Y direction and displaced from each other by a half pitch in the X direction. Referring to FIG. 11, in the ejection element substrate 340, common supply channels 18 each of which is in communication with a plurality of supply connection channels 323 arranged in the Y direction and common collecting channels 19 each of which is in communication with a plurality of collection connection channels 324 arranged in the Y direction are alternately arranged in the X direction. The common supply channel 18 and the common collecting channel 19 are provided for each type of ink, and the number of common supply channels 18 arranged and the number of common collecting channels 19 arranged depend on the number of arrays of ejection ports for each color. Furthermore, the number of supply connection channels 323 arranged and the number of collection connection channels 324 arranged also correspond to the number of ejection ports 13. Note that these components do not necessarily have to be in a one-to-one correspondence, and one supply connection channel 323 and one collection connection channel 324 may correspond to a plurality of ejection ports 13.

The opening plate 330 and the ejection element substrate 340 are overlaid and bonded to each other such that the ink channels are in communication with each other to form the ejection module 300, and supported on the first supporting member 4. In this way, the ink channels including the supply channels and the collecting channels described above are formed.

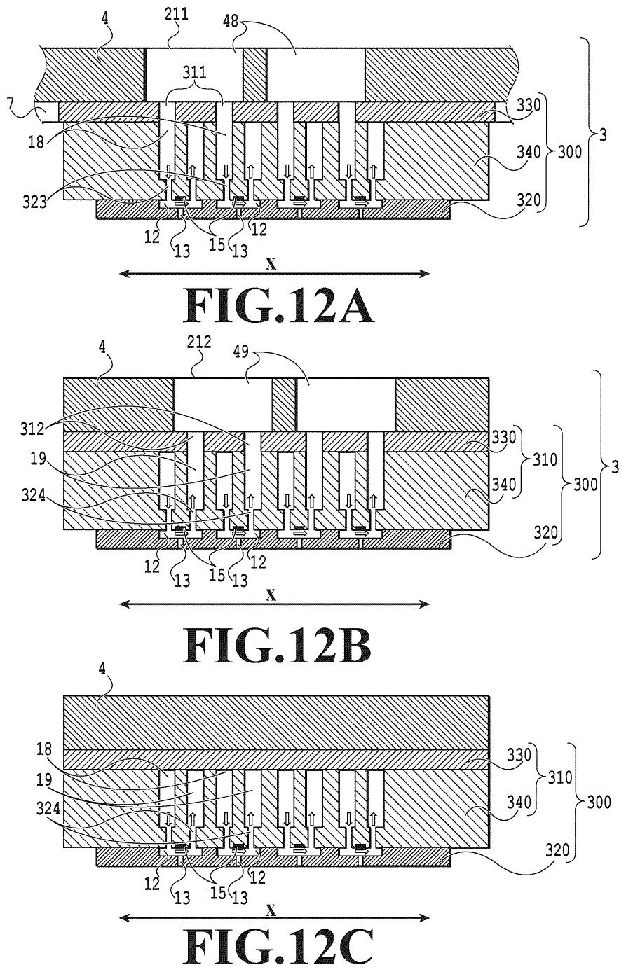

FIGS. 12A to 12C are cross-sectional views showing ink flows in different parts of the ejection unit 3. FIG. 12A shows a cross section of a part of the ejection unit 3 in which the ink supply channel 48 and the ink supply port 311 are in communication with each other taken along the line XIIa-XIIa in FIG. 9A. FIG. 12B shows a cross section of a part of the ejection unit 3 in which the ink collecting channel 49 and the ink collection port 312 are in communication with each other taken along the line XIIb-XIIb in FIG. 9A. FIG. 12C shows a cross section of the ejection unit 3 in which the ink supply port 311 and the ink collection port 312 are not in communication with channels in the first supporting member 4 taken along the line XIIc-XIIc in FIG. 9A.

In the supply channel for supplying ink, as shown in FIG. 12A, ink is supplied through the part where the ink supply channel 48 in the first supporting member 4 and the ink supply port 311 of the opening plate 330 are overlaid and in communication with each other. In the collecting channel for collecting ink, as shown in FIG. 12B, the ink is collected through the part where the ink collecting channel 49 in the first supporting member 4 and the ink collection port 312 of the opening plate 330 are overlaid and in communication with each other. Furthermore, as shown in FIG. 12C, in the ejection unit 3, there is a region of the opening plate 330 where no opening is provided. In such a region, supply and collection of ink do not occur between the ejection element substrate 340 and the first supporting member 4. Supply of ink occurs in the region where the ink supply port 311 is provided as shown in FIG. 12A, and collection of ink occurs in the region where the ink collection port 312 is provided as shown in FIG. 12B. Note that although this embodiment is described by taking as an example a configuration including the opening plate 330, the opening plate 330 does not have to be used. For example, channels corresponding to the ink supply channel 48 and the ink collecting channel 49 may be formed in the first supporting member 4, and the ejection element substrate 340 may be bonded to the first supporting member 4.

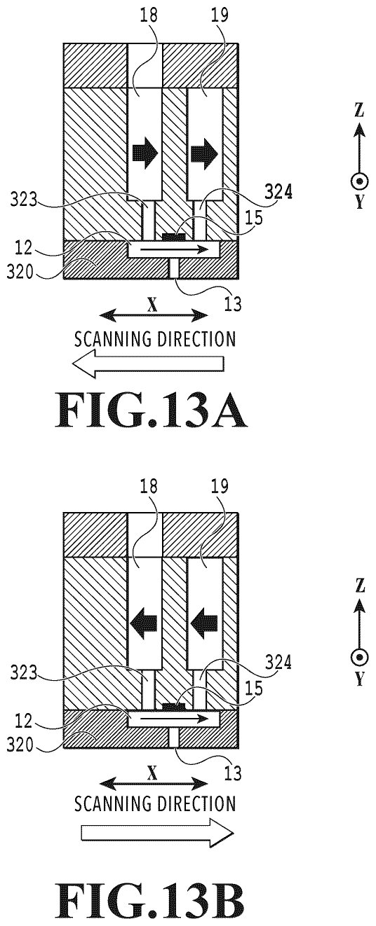

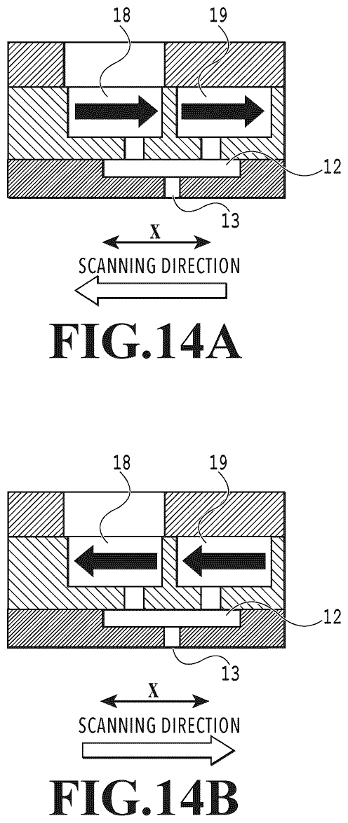

FIGS. 13A and 13B are cross-sectional views showing the ejection port 13 and its periphery in the ejection module 300, and FIGS. 14A and 14B are cross-sectional views showing an ejection module according to a comparative example in which the common supply channel 18 and the common collecting channel 19 are expanded in the X direction. Note that the thick arrows shown inside the common supply channel 18 and the common collecting channel 19 in FIGS. 13A, 13B, 14A, and 14B indicate fluctuations of ink in an arrangement using the serial-type liquid ejection apparatus 50. The ink supplied to the pressure chamber 12 through the common supply channel 18 and the supply connection channel 323 is ejected through the ejection port 13 when the ejection element 15 is activated. In the case where the ejection element 15 is not activated, the ink is collected from the pressure chamber 12 into the common collecting channel 19 through the collection connection channel 324, which is the collecting channel.

In the arrangement using the serial-type liquid ejection apparatus 50, when such circulating ink is ejected, the ejection of the ink is affected to some extent by the fluctuations of the ink inside the ink channels caused by the movement of the liquid ejection head 1. Specifically, the influence of the fluctuations of the ink in the ink channels manifests itself in the form of variations in ink ejection amount or shifting of the ink ejection direction. When the common supply channel 18 and the common collecting channel 19 have a cross-sectional shape widened in the X direction, which is the scanning direction, as shown in FIGS. 14A and 14B, the ink in the common supply channel 18 and the common collecting channel 19 is more susceptible to the inertial force in the scanning direction and significantly fluctuates. As a result, the fluctuations of the ink may affect the ejection of the ink through the ejection port 13. In addition, if the common supply channel 18 and the common collecting channel 19 are expanded in the X direction, distances between different colors increase, and the efficiency of printing may decrease.

In this regard, in the cross-sectional views of FIGS. 13A and 13B, both the common supply channel 18 and the common collecting channel 19 according to this embodiment extend not only in the Y direction but also in the Z direction perpendicular to the X direction, which is the scanning direction. With such a configuration, the width of each of the common supply channel 18 and the common collecting channel 19 in the scanning direction can be reduced. Since the width of each of the common supply channel 18 and the common collecting channel 19 in the scanning direction is reduced, the fluctuations of the ink caused by the inertial force (indicated by the black thick arrows in the drawings) acting on the ink in the common supply channel 18 and the common collecting channel 19 in the opposite direction to the scanning direction during movement can be reduced. Accordingly, the influence of the fluctuations of the ink on the ejection of the ink can be reduced. Furthermore, since the common supply channel 18 and the common collecting channel 19 extend in the Z direction, the cross-sectional area is increased, and the channel pressure loss is reduced.

As described above, by reducing the width of each of the common supply channel 18 and the common collecting channel 19 in the scanning direction, the fluctuations of the ink in the common supply channel 18 and the common collecting channel 19 during movement are reduced. However, the fluctuations are not completely eliminated. Thus, according to this embodiment, in order to reduce variations of ejection among different types of ink that can be caused by the reduced fluctuations, the common supply channel 18 and the common collecting channel 19 are aligned with each other when viewed from the X direction.

As described above, in this embodiment, the supply connection channel 323 and the collection connection channel 324 are provided in correspondence with the ejection port 13. Specifically, the supply connection channel 323 and the collection connection channel 324 are arranged on opposite sides of the ejection port 13 in the X direction. Therefore, if the common supply channel 18 and the common collecting channel 19 are partially misaligned with each other when viewed from the X direction, and the supply connection channel 323 and the collection connection channel 324 are misaligned with each other when viewed from the X direction, the flow of the ink in the X direction in the pressure chamber 12 and the ejection of the ink are affected. The ejection of the ink through each ejection port may be further affected by this influence, in addition to the fluctuations of the ink.

In this regard, by aligning the common supply channel 18 and the common collecting channel 19 with each other when viewed from the X direction, the fluctuations of the ink in the common supply channel 18 and the common collecting channel 19 during movement are made substantially uniform at any position along the Y direction in which the ejection ports 13 are arranged. As a result, the pressure difference occurring in the pressure chamber 12 between the side of the common supply channel 18 and the side of the common collecting channel 19 does not substantially vary, and stable ejection can be achieved.

In some liquid ejection heads involving ink circulation, ink is supplied to and collected from the liquid ejection head through the same channel. According to this embodiment, however, different channels, the common supply channel 18 and the common collecting channel 19, are provided. In addition, the supply connection channel 323 and the pressure chamber 12 are in communication with each other, the pressure chamber 12 and the collection connection channel 324 are in communication with each other, and ink is ejected through the ejection port 13 of the pressure chamber 12. That is, the pressure chamber 12, which is a path connecting the supply connection channel 323 and the collection connection channel 324 to each other, includes the ejection port 13. Therefore, an ink flow occurs from the side of the supply connection channel 323 to the side of the collection connection channel 324 in the pressure chamber 12, and the ink in the pressure chamber 12 is efficiently circulated. Since the ink in the pressure chamber 12 is efficiently circulated, the ink in the pressure chamber 12, which is susceptible to evaporation through the ejection port 13, can be kept in a fresh state.

Furthermore, since the two channels, the common supply channel 18 and the common collecting channel 19, are in communication with the pressure chamber 12, ink can be supplied through both channels when ejection at high flowrate is needed. That is, compared with the configuration in which one channel is used for ink supply and collection, the configuration according to this embodiment can advantageously not only efficiently circulate ink but also be used for ejection at high flowrate.

Furthermore, the common supply channel 18 and the common collecting channel 19 are less affected by the fluctuations of ink when the channels are arranged closer to each other in the X direction. The distance between the common supply channel 18 and the common collecting channel 19 is desirably 75 μm to 100 μm.

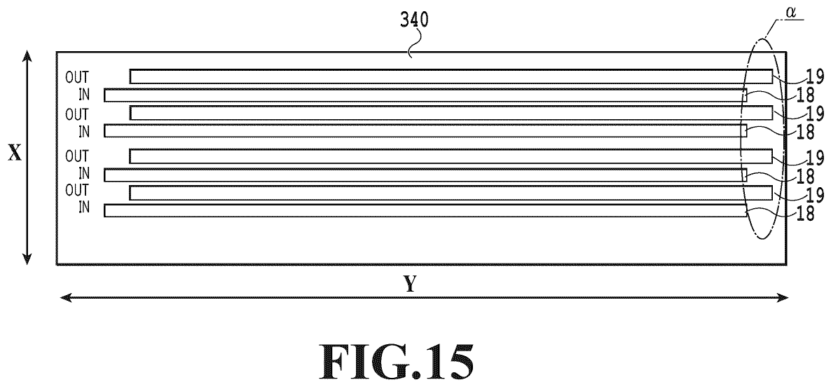

FIG. 15 is a diagram showing an ejection element substrate 340 according to a comparative example. Note that the supply connection channel 323 and the collection connection channel 324 are not shown in FIG. 15. Ink having received thermal energy from the ejection element 15 in the pressure chamber 12 flows into the common collecting channel 19, so that ink having a higher temperature than the ink in the common supply channel 18 flows through the common collecting channel 19. In the comparative example, the ejection element substrate 340 has a part α outlined by the alternate long and short dash line in FIG. 15 in which there are only the common collecting channels 19. In this case, the temperature locally rises in this part, and a temperature unevenness occurs in the ejection module 300, which can affect the ejection.

Ink at a lower temperature than the ink in the common collecting channel 19 flows through the common supply channel 18. Therefore, if the common supply channel 18 and the common collecting channel 19 are adjacent to each other, the temperatures of the ink in the common supply channel 18 and the common collecting channel 19 are equalized to some extent in their proximity, so that the temperature rise is reduced. Therefore, the common supply channel 18 and the common collecting channel 19 desirably have substantially the same length, and are aligned with each other when viewed from the X direction and adjacent to each other in the X direction.

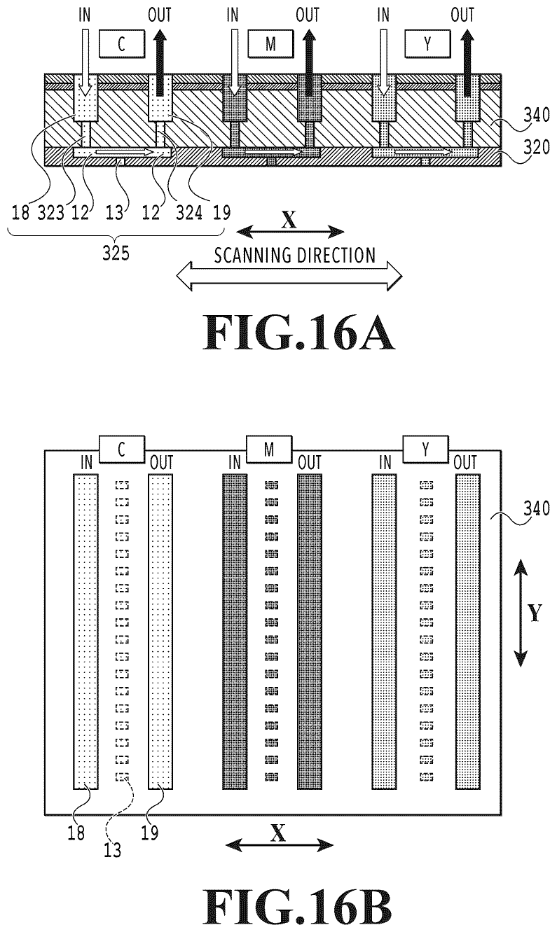

FIGS. 16A and 16B are diagrams showing a channel configuration of the liquid ejection head 1 designed for inks of three colors, cyan (C), magenta (M) and yellow (Y). As shown in FIG. 16A, in the liquid ejection head 1, a circulation channel 325 is provided for each type of ink. The pressure chamber 12 is provided along the X direction, which is the scanning direction of the liquid ejection head 1. Furthermore, as shown in FIG. 16B, the common supply channel 18 and the common collecting channel 19 are provided along the ejection port array in which the ejection ports 13 are arranged in such a manner that the common supply channel 18 and the common collecting channel 19 extend in the Y direction on the opposite sides of the ejection port array. The circulation channel 325 is a channel that includes the common supply channel 18, the common collecting channel 19, the pressure chamber 12, the ejection port 13, the supply connection channel 323, and the collection connection channel 324.

Although the liquid ejection apparatus 50 including the liquid ejection head 1 having the diaphragm pump 500 has been described, the diaphragm pump 500 may be provided outside the liquid ejection head 1 in the housing of the liquid ejection apparatus 50. In that case, the diaphragm pump 500 makes the liquid in the liquid ejection head 1 circulate between the liquid ejection head 1 and the diaphragm pump 500. Since the distance between the diaphragm pump 500 and the ejection ports 13 is increased, the effect of the pulsation of the diaphragm pump 500 on the ejection stability decreases.

According to the configuration described above, since the diaphragm pump 500 is provided in the liquid ejection head 1, the decrease in strength of bonding between the diaphragm and the supporting members is reduced, so that the flowrate of the circulated liquid can be stabilized for a long period. In addition, by providing the liquid ejection head 1 having the diaphragm pump 500 in the liquid ejection apparatus 50, the flowrate of the circulated liquid can be stabilized for a long period.

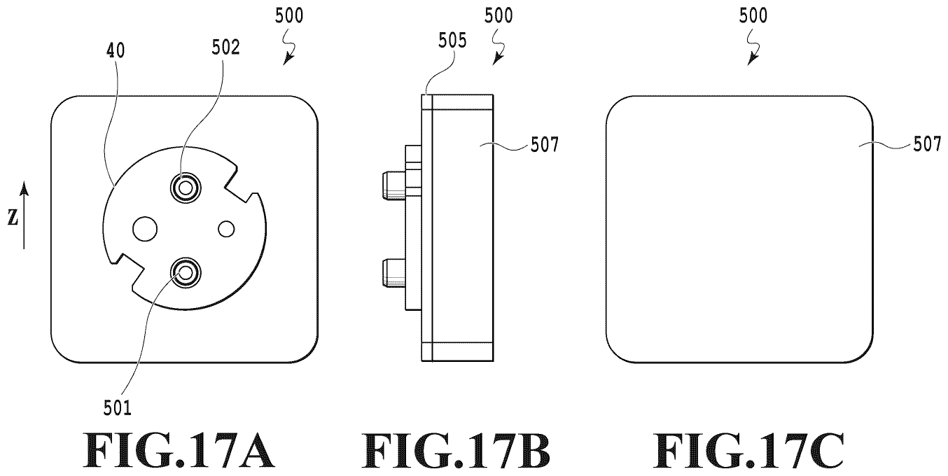

FIGS. 17A to 17C are exterior views of the diaphragm pump 500, FIG. 17A is a front view, FIG. 17B is a side view, and FIG. 17C is a rear view. Note that the directions X, Y and Z in the description of the diaphragm pump do not necessarily agree with the directions X, Y and Z in the description of FIGS. 1A to 16B. The diaphragm pump 500 has a channel member 40, and a suction hole 501 for sucking in a fluid and a discharge hole 502 for discharging the fluid that are provided in the channel member 40. The fluid entering the suction hole 501 passes through the pump and is discharged through the discharge hole 502. The suction hole 501 is connected to the pump inlet channel 170 (see FIG. 5). The ink collected through the collecting channel 140 (see FIG. 5) is sucked in by the diaphragm pump 500 through the pump inlet channel 170 and the suction hole 501. The discharge hole 502 is connected to the pump outlet channel 180 (see FIG. 5), and the ink discharged to the pump outlet channel 180 is supplied to the supply channel 130 (see FIG. 5).

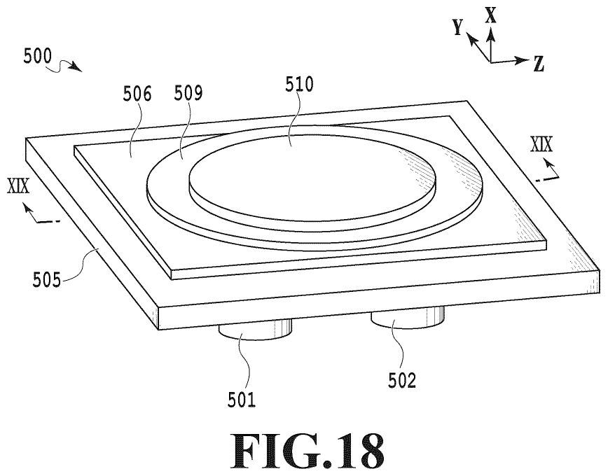

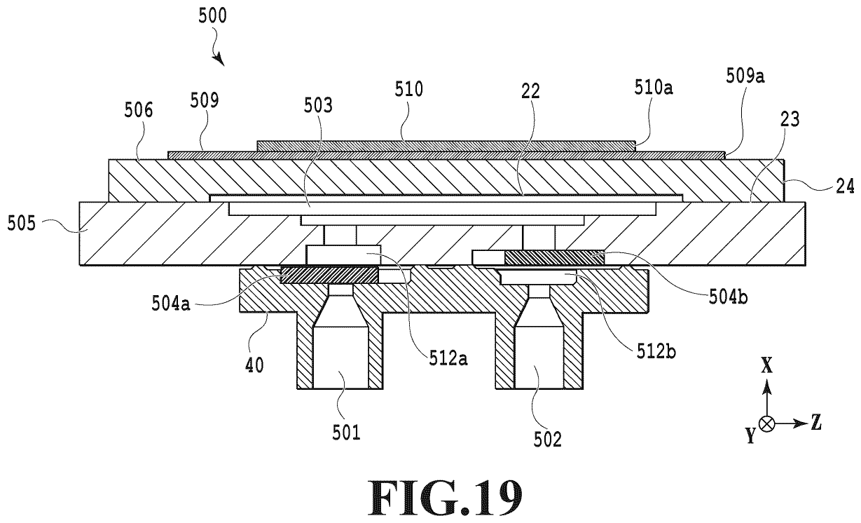

FIG. 18 is a perspective view of the diaphragm pump 500 without a cover 507, and FIG. 19 is a cross-sectional view taken along the line XIX-XIX in FIG. 18. In the diaphragm pump 500, on a supporting member 505, a diaphragm 506, an electrode plate 509 and a piezoelectric body 510 are stacked in this order in the X direction. The piezoelectric body 510 serves to convert applied electric energy into mechanical energy. That is, the diaphragm pump 500 makes a fluid flow by the piezoelectric body 510 to which a voltage is applied being deformed and thereby the diaphragm 506 being deformed.

The electrode plate 509 is disposed in contact with the piezoelectric body 510 so as to supply electric power to the piezoelectric body 510. The electrode plate 509 further serves to facilitate transmission of the vibration of the piezoelectric body 510 to the diaphragm 506. Thus, even when the piezoelectric body 510 has a small area, the diaphragm 506 can be made to strongly vibrate. In the cases where there is a cable (not shown) for supplying electric power to the piezoelectric body 510 that is separate from the electrode plate 509, the diaphragm pump 500 does not have to include the electrode plate 509.

The diaphragm 506 is a vibrating membrane that is deformed (vibrates) as the piezoelectric body 510 is activated to expand and contract the volume in a pump chamber 503 (see FIG. 19). The diaphragm 506 is made of a material that can be injection-molded, such as a modified PPE-PS blend or polypropylene, and may be produced by punching of a film or a resin plate. Furthermore, the diaphragm 506 may be single-layer or multilayer.

The diaphragm 506 and the electrode plate 509 are bonded to each other with an adhesive (not shown), and the electrode plate 509 and the piezoelectric body 510 are bonded to each other with an adhesive (not shown). Furthermore, the suction hole 501 and the discharge hole 502 are formed in a lower face of the supporting member 505 (see FIG. 19). The suction hole 501 is a hole through which a fluid can be supplied to the pump chamber 503. The discharge hole 502 is a hole through which a fluid can be discharged from the pump chamber 503.

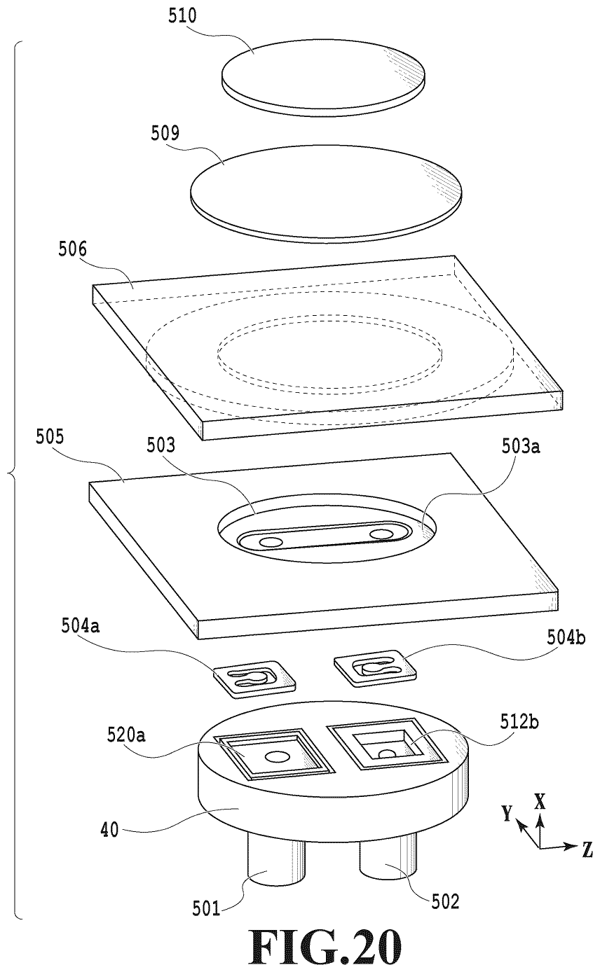

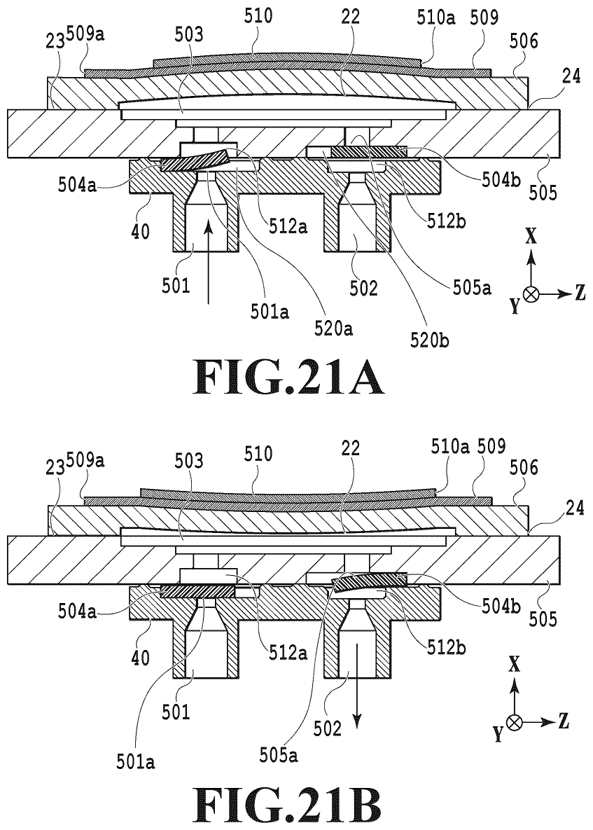

FIG. 20 is an exploded perspective view of the diaphragm pump 500 without the cover 507, and FIGS. 21A and 21B are cross-sectional views of the diaphragm pump 500 without the cover 507. In a face of the supporting member 505, a recess part 503a having a cylindrical shape is formed. The recess part 503a is a space that is opposed to the diaphragm 506 and serves as the pump chamber 503. Furthermore, a check valve 504a having a plate shape is provided in a valve housing recess portion 520a that is provided in the channel member 40 (as a communication portion) between the suction hole 501 and the pump chamber 503. Furthermore, a check valve 504b is provided in a valve housing recess portion 520b (see FIG. 21A described later) that is provided in the supporting member 505 (as a communication portion) between the pump chamber 503 and the discharge hole 502. The check valves 504a and 504b are made of a flexible material.

The check valve 504a is a valve that prevents a fluid in a space 512a (see FIG. 21A) formed in the suction hole 501 from flowing (back) in the −X direction. Thus, the fluid in the space 512a flows to the pump chamber 503. The check valve 504b is a valve that prevents a fluid in a space 512b formed in the discharge hole 502 from flowing (back) to the pump chamber 503. Thus, the fluid in the space 512b flows in the −X direction.

FIG. 21A shows a state during sucking of the fluid, and FIG. 21B shows a state during discharging of the fluid. In the diaphragm pump 500, when the diaphragm 506 is displaced such that the volume of the pump chamber 503 increases and the pressure in the pump chamber 503 decreases, the check valve 504a separates from an opening 501a of the suction hole 501 in the space 512a (moves in the +X direction) as shown in FIG. 21A. By separating from the opening 501a, the check valve 504a enters the open state in which the fluid can flow between the suction hole 501 and the space 512a. When the diaphragm 506 is displaced such that the volume of the pump chamber 503 decreases and the pressure in the pump chamber 503 increases, the check valve 504a comes into intimate contact with the wall around the opening 501a of the suction hole 501. As a result, the check valve 504a enters the closed state where the flow of the fluid in the suction hole 501 is blocked.

On the other hand, when the pressure in the pump chamber 503 decreases, the check valve 504b comes into intimate contact with the wall around an opening 505a of the supporting member 505 and enters the closed state in which the flow of the fluid in the discharge hole 502 is blocked. When the pressure in the pump chamber 503 increases, the check valve 504b separates from the opening 505a of the supporting member 505, moves toward the space 512b (moves in the −X direction in the drawing), and enters the open state in which the fluid can flow between the discharge hole 502 and the pump chamber 503.

Note that the check valves 504a and 504b can be any material that can be deformed under pressure in the pump chamber 503, and may be made of an elastic material, such as EPDM or elastomer, or may be formed of a film or thin plate of polypropylene or the like. However, the material of the check valves is not limited to these materials.

The check valves 504a and 504b may be produced by die molding, punching of a sheet with a cutting die, laser cutting, or cutting with a cutting plotter, for example. However, the production method is not limited to these methods and can be appropriately chosen based on the material, shape, and size. In the case where the size is on the order of several millimeters and the shape is complicated, like the check valves in this embodiment, the dimensional accuracy is likely to be achieved by laser machining.

As described above, the pump chamber 503 is formed by bonding the supporting member 505 and the diaphragm 506 to each other. Therefore, when the diaphragm 506 is deformed, the volume of the pump chamber 503 changes, and the pressure in the pump chamber 503 changes. For example, when the diaphragm 506 is displaced toward the supporting member 505 (displaced downward in the drawing) and the volume of the pump chamber 503 decreases, the pressure in the pump chamber 503 increases. As a result, the check valve 504b disposed to be opposed to the discharge hole 502 enters the open state, and the fluid in the pump chamber 503 is discharged. In the meanwhile, the check valve 504a disposed to be opposed to the suction hole 501 is in intimate contact with the wall around the suction hole 501, so that the backflow of the fluid from the pump chamber 503 to the suction hole 501 is prevented.

On the other hand, when the diaphragm 506 is displaced toward the piezoelectric body 510 (displaced in the +X direction in the drawing) and the volume of the pump chamber 503 increases, the pressure in the pump chamber 503 decreases. As a result, the check valve 504a disposed to be opposed to the suction hole 501 enters the open state, and the fluid is supplied to the pump chamber 503. In the meanwhile, the check valve 504b disposed at the discharge hole 502 is in intimate contact with the wall around the opening 505a formed in the supporting member 505 to close the opening 505a. Therefore, the backflow of the fluid from the discharge hole 502 to the pump chamber 503 is prevented.

As described above, the diaphragm pump 500 sucks in and discharges a fluid by the diaphragm 506 being deformed to change the pressure in the pump chamber 503. In particular, if there are bubbles in the pump chamber 503 when sucking in and discharging a liquid, the change of the pressure in the pump chamber 503 decreases because of expansion and contraction of the bubbles when the diaphragm 506 is deformed. If the pressure change decreases, the amount of the liquid that can be sucked in and discharged decreases.

In view of this, in order to facilitate gathering of bubbles in an upper part of the pump chamber 503 in the Z direction, the pump chamber 503 preferably extends in the vertical direction in the posture of the diaphragm pump 500 during use. The diaphragm pump 500 may be inclined as long as bubbles are gathered in an upper part of the pump chamber 503 in the Z direction. Here, the posture of the diaphragm pump 500 during use means the posture of the diaphragm pump 500 in which the diaphragm pump 500 is used to serve the function of a pump, that is, the posture of the diaphragm pump 500 in which the discharge hole 502 is located above the suction hole 501 in the vertical direction (Z direction) as shown in FIG. 17. In order to also discharge bubbles from the pump chamber 503, the discharge hole 502 is preferably located above the suction hole 501. Furthermore, in order to facilitate discharging of bubbles from the discharge hole 502, the discharge hole 502 is preferably formed above the vertical center of the pump chamber 503 in the Z direction. In this way, the flowrate of the pump can be stabilized.

In this embodiment, on the side toward the pump chamber, the diaphragm 506 includes a flat vibrating face 22 (referred to also as a first face) and a projection portion 24 that projects to a certain height (projects downward in the drawings) to be bonded to an upper face of the supporting member 505. A face of the projection portion 24 that is to be bonded to the supporting member 505 is referred to as a second face 23. That is, provided that the direction of movement of the first face 22 that is being deformed to cause a decrease in volume of the space 503 is the −X direction, the second face 23 is located in the −X direction compared with the first face 22. Thus, when the piezoelectric body 510 is activated to cause deformation of the electrode plate 509 and vibration of the diaphragm 506, the second face 23 is less affected by the moment of the vibration, since the first face 22 and the second face 23, which is a bonding face, are different faces that are not connected to each other.

Furthermore, a projection of an outer peripheral edge 509a of the electrode plate 509 onto the supporting member 505 preferably lies within the bonding region (second face 23) where the supporting member 505 and the diaphragm 506 are bonded to each other. In this way, the distance between the outer peripheral edge 509a and the bonding region in the direction perpendicular to the direction of vibration of the diaphragm 506 is decreased, and the influence of the moment of the vibration can be further reduced.

Although a case has been described above in which the diaphragm pump 500 has the diaphragm 506, the electrode plate 509 and the piezoelectric body 510 stacked in this order on the supporting member 505, the electrode plate 509 may be omitted. That is, the diaphragm 506 may be directly bonded to the piezoelectric body 510. Also in this case, by bonding the second face 23 different from the first face 22 to the supporting member 505, the influence of the moment of the vibration on the bonded part can be reduced. In addition, a projection of the outer peripheral edge 510a of the piezoelectric body is preferably located within the second face. In this way, the distance between the outer peripheral edge 510a of the piezoelectric body 510 and the bonding region in the direction perpendicular to the direction of vibration of the diaphragm 506 is decreased, and the influence of the moment of the vibration can be further reduced.

Furthermore, although the second face 23 projects toward the supporting member 505 beyond the first face 22 in FIG. 21A, the second face 23 may be more recessed than the first face 22 from the supporting member 505. In other words, provided that the direction of movement of the first face 22 that is being deformed to cause a decrease in volume of the space 503 is the −X direction, the second face 23 may be located below the first face 22 or may be located in the +X direction compared with the first face 22. That is, the first face 22 and the second face 23 have only to be different faces that are not directly connected to each other.

Furthermore, when the diaphragm 506 is bonded to the supporting member 505 in the direction of the back-and-forth movement of the carriage 60, that is, when the second face 23 is orthogonal to the direction of back-and-forth movement of the mount part, an inertial force occurs in such a direction as to separate the diaphragm 506 from the supporting member 505. Therefore, in such a case, the strength of bonding between the diaphragm 506 and the supporting member 505 further decreases. Thus, when the second face 23 is orthogonal to the direction of back-and-forth movement of the mount part, the diaphragm pump 500 according to this embodiment is preferably mounted in the liquid ejection head 1.

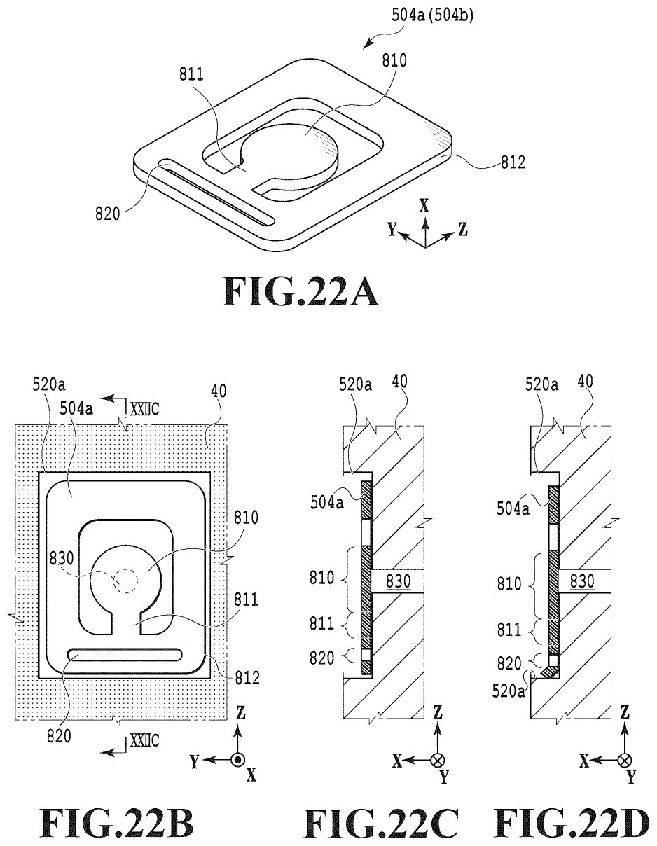

FIGS. 22A to 22D are diagrams showing the check valve 504a to which this embodiment can be applied. Note that the check valve 504a that is a check valve on the suction side of the diaphragm 506 will be described here, this embodiment can also be applied to the check valve 504b that is a check valve on the discharge side.

FIG. 22A is a perspective view of the check valve 504a, FIG. 22B is a top view showing shapes of the check valve and the channel member and a positional relationship therebetween, and FIG. 22B is a cross-sectional view taken along the line XXIIc-XXIIc in FIG. 22B. FIG. 22D is a cross-sectional view taken along the line XXIIc-XXIIc in FIG. 22B showing a state where the check valve 504a has gotten caught on the wall of the valve housing recess portion 520a.

As shown in FIG. 22A, the check valve 504a includes a flap piece portion 810, a flexible portion 811 that bends when opening and closing the check valve 504a, and an outer peripheral portion 812 that surrounds the flap piece portion 810 and forms the outer shape of the check valve 504a. A slit 820 is formed between the outer peripheral portion 812 and the flexible portion 811. The slit 820 extends in the Y direction. As shown in FIGS. 22B and 22C, the check valve 504a is set (mounted) in the valve housing recess portion 520a of the channel member 40, and the flap piece portion 810 closes an opening 830 of the channel member 40. The flexible portion 811 is elastically deformed when the opening 830 is opened and closed by the flap piece portion 810.

As shown in FIG. 22D, in a state where the check valve 504a is displaced in the −Z direction from an ideal position in the valve housing recess portion 520a and get caught on the wall of the valve housing recess portion 520a at an edge thereof, the check valve 504a is deformed at the slit 820. As a result, the force exerted on the flexible portion 811 from the wall of the valve housing recess portion 520a is reduced, and the valve opening and closing operation can be smoothly achieved.

Outer dimensions of the check valve 504a in this embodiment are a longitudinal dimension in the Z direction of 4.8 millimeters, a lateral dimension in the Y direction of 3.8 millimeters and a thickness in the X direction of 0.22 millimeters. Dimensions of the slit 820 are a longitudinal dimension in the Z direction of 0.4 millimeters and a lateral dimension in the Y direction of 2.8 millimeters, a diameter of the flap piece portion 810 is 1.6 millimeters, and a lateral dimension in the Y direction of the flexible portion 811 is 0.8 millimeters. By providing the slit 820 in this embodiment, the stress caused by the check valve 504a coming into contact with the outer peripheral portion can be relieved to reduce the distortion of the flexible portion 811. In this way, the sealing of the opening 830 of the channel member 40 in the valve opening/closing operation can be stabilized.

Note that although the slit 820 in this embodiment has been described as one straight elongated hole penetrating the check valve 504a as an example, this is not intended to be limiting. That is, the check valve has only to have a deformable part that can be deformed to relieve the stress caused by a force externally applied to the check valve. For example, the deformable part may be formed by a plurality of elongated holes penetrating the check valve, an array of a plurality of through-holes, or a groove or recess that does not penetrate the check valve. The recess may be a recess in the +X direction or −X direction in the check valve 504a or may be a combination of a recess in the +X direction and a recess in the −X direction. That is, a groove or recess may be formed in both faces of the check valve 504a. These deformable parts are required to be able to be sufficiently deformed in response to an external force and relieve the stress occurring in the flexible portion 811.

Furthermore, although this embodiment has been described by taking as an example the diaphragm pump that causes a flow of a liquid by making the diaphragm vibrate in response to a voltage being applied to the piezoelectric body, this is not intended to be limiting. This embodiment can also be applied to a diaphragm pump that includes no piezoelectric body.

### (Modifications)

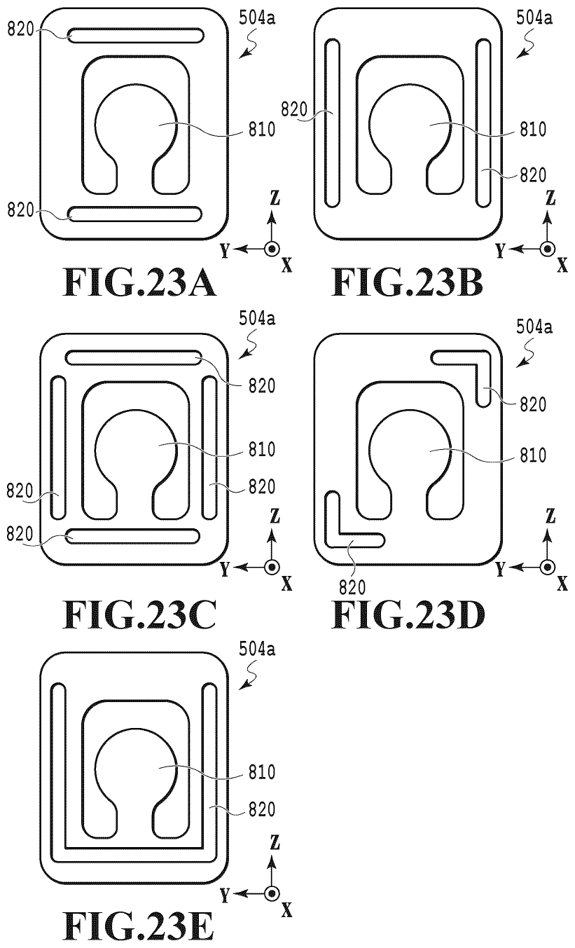

FIGS. 23A to 23E are diagrams showing check valves 504a according to modifications of this embodiment. As shown in FIGS. 23A and 23B, slits 820 may be arranged on opposite sides of flap piece portion 810 in the Z direction or the Y direction. Alternatively, as shown in FIG. 23C, slits 820 may be arranged to surround the flap piece portion 810. Furthermore, the shape of the slit 820 is not limited to a straight shape, and as shown in FIG. 23D, L-shaped slits 820 may be arranged at some or all of the four corners of the check valve 504a (only two slits 820 are shown in the drawing), or as shown in FIG. 23E, a U-shaped slit (formed by L-shaped slits connected to each other) may be arranged along three sides of the check valve 504a connected to each other. Note that the open part of the U-shaped slit (the part of the check valve where no slit is formed) may be provided at any of the four sides of the check valve 504a.

As described above, the check valve according to this embodiment includes a deformable part that can be deformed between the flap piece portion and the outer peripheral portion. In this way, the decrease in pump performance can be reduced.

### Second Embodiment

In the following, a second embodiment of the present disclosure will be described with reference to the drawings. Note that the basic configuration according to this embodiment is the same as that according to the first embodiment, and therefore, only characteristic components will be described below.

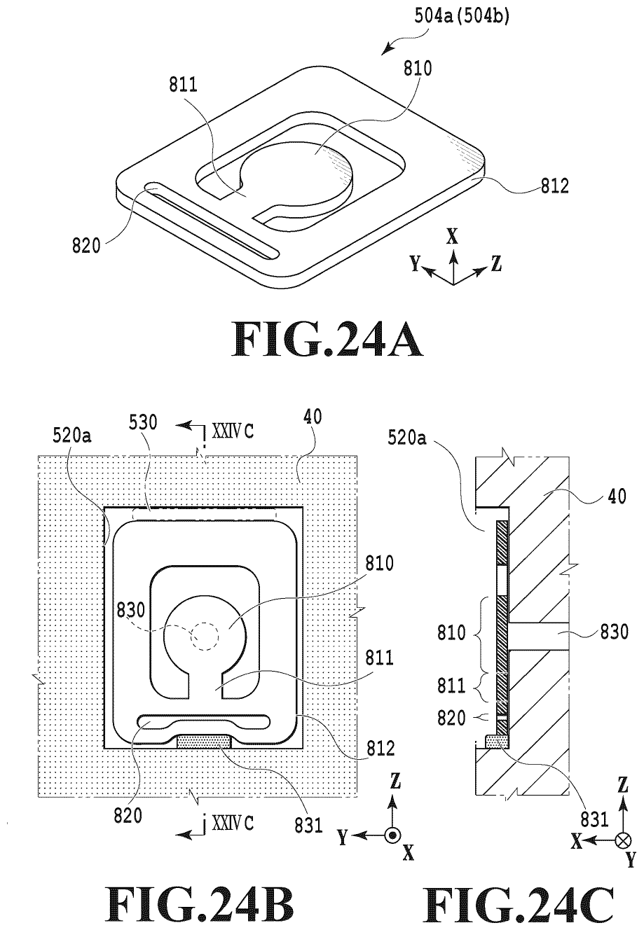

FIGS. 24A to 24C are diagrams showing a valve mechanism to which this embodiment can be applied. FIG. 24A is a perspective view of a check valve 504a, FIG. 24B is a top view showing shapes of the check valve and a channel member and a positional relationship therebetween, and FIG. 24C is a cross-sectional view taken along the line XXIVc-XXIVc in FIG. 24B.

Although the check valve 504a according to this embodiment is similar to the check valve according to the first embodiment, a valve housing recess portion 520a of a channel member 40 includes a protrusion 831 at a position opposed to the slit 820 of the check valve 504a. The protrusion 831 is provided so as to be able to come into contact with the outer peripheral portion 812 of the check valve 504a. The lateral dimension in the Y direction of the protrusion 831 is smaller than the lateral dimension of the slit 820, and the longitudinal dimension in the Z direction of the protrusion 831 is smaller than the longitudinal dimension of the slit 820. In addition, the height in the X direction of the protrusion 831 is greater than the height of the check valve 504a.

In a process of assembling the check valve 504a into the valve housing recess portion 520a, the check valve 504a is set so as to abut against the protrusion 831. Although the outer peripheral portion 812 of the check valve 504a is deformed as a result of the check valve 504a abutting against the protrusion 831, the slit 820 can prevent deformation of the flexible portion 811. In addition, since the check valve 504a is set with respect to the protrusion 831, a sufficient clearance can be provided in a region 530 close to the inner wall of the valve housing recess portion 520a on the opposite side to the protrusion 831.

Note that although the protrusion 831 is provided on the side of the valve housing recess portion 520a at one end in the Z direction, this is not intended to be limiting. The protrusion 831 may be provided on any of the sides of the valve housing recess portion 520a depending on the position of the slit 820 formed in the check valve 504a.

The protrusion 831 may be integrally formed with the channel member 40 or formed as a separate body from the channel member 40.

According to this embodiment, the sealing performance of the flap piece portion 810 in the valve opening/closing operation at the opening 830 of the channel member 40 can be stabilized. Note that even if the outer peripheral portion 812 goes beyond abutting against the protrusion 831 and gets caught on the protrusion 831, the slit 820 allows sufficient deformation, so that the sealing performance of the flap piece portion 810 can be stabilized.

### (Modifications)

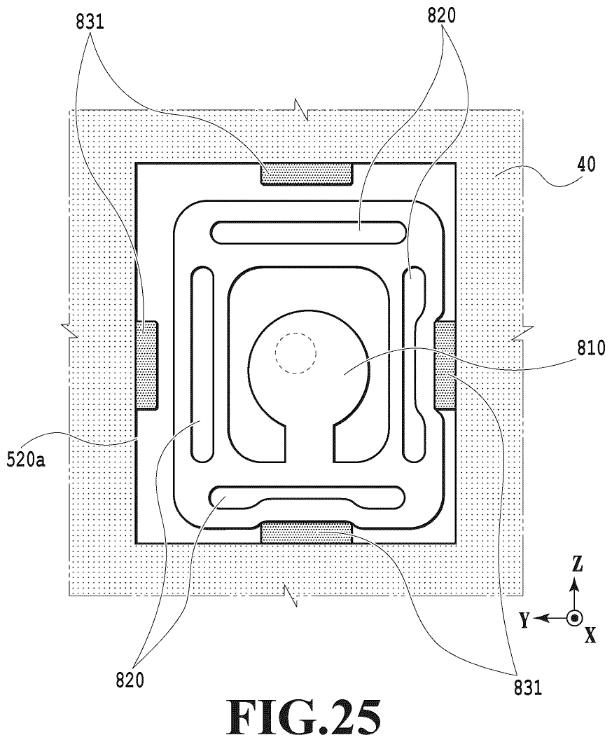

FIG. 25 is a diagram showing a check valve 504a and a valve housing recess portion 520a according to a modification of this embodiment. As shown in FIG. 25, four slits are provided to surround the outer periphery of a flap piece portion 810, and four protrusions 831 corresponding to the slits are provided on the valve housing recess portion 520a of the channel member 40. In this modification, the stress can be relieved at the four sides of the valve housing recess portion 520a surrounding the outer periphery of the flap piece portion 810. That is, even if the check valve 504a mounted in the valve housing recess portion 520a is displaced in any direction from an ideal position, the sealing performance of the flap piece portion 810 can be stabilized. Furthermore, when setting the check valve 504a, any of the four sides of the valve housing recess portion 520a can be used as a reference, and the workability can be improved.

Note that although the protrusions 831 are provided on the four sides of the valve housing recess portion 520a in this modification, this is not intended to be limiting. A plurality of protrusions 831 may be provided on any of the four sides of the valve housing recess portion 520a. Furthermore, each configuration can be appropriately modified according to the material, thickness, dimensions, and workability in assembly of the check valve and the production method for the check valve, for example.

In this embodiment, as in the first embodiment, the deformable part is not limited to the slit 820. For example, the deformable part may be formed by a plurality of elongated holes penetrating the check valve, an array of a plurality of through-holes, or a groove or recess that does not penetrate the check valve. The recess may be a recess in the +X direction or −X direction in the check valve 504a or may be a combination of a recess in the +X direction and a recess in the −X direction. That is, a groove or recess may be formed in both faces of the check valve 504a.

In this way, the stress caused by the check valve coming into contact with the outer peripheral portion can be relieved to reduce the distortion of the flexible portion, so that the sealing of the opening of the valve housing recess portion in the valve opening/closing operation can be ensured.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-041178, filed Mar. 14, 2025, which is hereby incorporated by reference herein in its entirety.

What is claimed is:

1. A diaphragm pump, comprising:
a diaphragm that is deformable;
a supporting member that supports the diaphragm;
an opening portion that is in communication with a space formed between the diaphragm and the supporting member; and
a check valve having a plate shape that is provided between the opening portion and the space and is configured to open and close an opening that is in communication with the opening portion,
wherein the check valve has:
a flap piece portion that opens and closes the opening;
an outer peripheral portion that surrounds the flap piece portion and forms an outer shape of the check valve; and
a flexible portion that connects the flap piece portion and the outer peripheral portion to each other,
wherein the flexible portion bends to allow the flap piece portion to open and close the opening, and
wherein the check valve includes a slit formed between the flap piece portion and the outer peripheral portion.

2. The diaphragm pump according to claim 1, wherein the diaphragm is deformed under an action of a piezoelectric body.

3. The diaphragm pump according to claim 1, wherein the opening portion is a suction hole through which a liquid is supplied to the space or a discharge hole through which a liquid is discharged from the space.

4. The diaphragm pump according to claim 1, wherein the slit is a through-hole.

5. The diaphragm pump according to claim 1, wherein the slit is a groove.

6. The diaphragm pump according to claim 5, wherein the groove is formed in each of opposite faces of the check valve.

7. The diaphragm pump according to claim 1, wherein the slit is an elongated hole extending in a straight line.

8. The diaphragm pump according to claim 1, wherein the outer peripheral portion has an outer shape having four sides, and
the slit is formed along each of two opposed sides.

9. The diaphragm pump according to claim 1, wherein the outer peripheral portion has an outer shape having four sides, and
the slit is formed along each of the four sides.

10. The diaphragm pump according to claim 1, wherein the outer peripheral portion has an outer shape having four sides, and
the slit has an L-shape and is formed between two sides that are not opposed to each other.

11. The diaphragm pump according to claim 10, wherein a plurality of the slits have an L-shape.

12. The diaphragm pump according to claim 1, wherein the outer peripheral portion has an outer shape having four sides, and
the slit has a U-shape and is formed along three sides connected to each other.

13. The diaphragm pump according to claim 1, further comprising:
a valve housing recess portion that houses the check valve,
wherein the valve housing recess portion includes a protrusion that is opposed to a part of the check valve where the slit is formed and that is configured to come into contact with the outer peripheral portion.

14. The diaphragm pump according to claim 13, wherein in a direction in which the slit extends, a length of the protrusion is shorter than a length of the slit.

15. The diaphragm pump according to claim 13, wherein in a thickness direction of the check valve, a thickness of the protrusion is greater than a thickness of the check valve.

16. The diaphragm pump according to claim 13, wherein in a direction in which the protrusion protrudes from an inner wall of the valve housing recess portion, a length of the protrusion is shorter than a length of the slit.

17. A liquid ejection head, comprising:
an ejection port for ejecting a liquid;
an ejection element that produces energy for ejecting the liquid through the ejection port;
a pressure chamber on which the energy produced by the ejection element is applied;
a first channel connected to the pressure chamber and configured to supply the liquid to the pressure chamber;
a second channel connected to the pressure chamber; and
the diaphragm pump according to claim 1, wherein the diaphragm pump causes the liquid in the second channel to flow into the first channel.

18. The liquid ejection head according to claim 17, wherein the liquid ejection head is a serial type that ejects the liquid while moving.

19. The liquid ejection head according to claim 18, further comprising a circulation channel for the liquid.

20. A liquid ejection apparatus comprising the liquid ejection head according to claim 19, the liquid ejection head being configured to be mounted to the apparatus.
